(19) United States
(12) Patent Application Publication
(10) Pub. No.: US 2026/0019962 A1
(43) Pub. Date: Jan. 15, 2026

(54) TIME-AVERAGED RADIO FREQUENCY (RF) EXPOSURE COMPLIANCE ACROSS ANTENNA GROUPING TRANSITIONS

(71) Applicant: QUALCOMM Incorporated, San Diego, CA (US)

(72) Inventors: Lin LU, San Diego, CA (US); Jagadish NADAKUDUTI, San Diego, CA (US); Paul GUCKIAN, La Jolla, CA (US)

(21) Appl. No.: 19/268,870

(22) Filed: Jul. 14, 2025

Related U.S. Application Data
(60) Provisional application No. 63/671,628, filed on Jul. 15, 2024.
(60) Provisional application No. 63/727,498, filed on Dec. 3, 2024.

(51) Int. Cl. H04W 52/36; H04W 52/02; H04W 52/42

(52) U.S. Cl. CPC H04W 52/367; H04W 52/0232; H04W 52/42

(57) ABSTRACT

Methods and apparatus for radio frequency (RF) exposure compliance across antenna grouping transitions are described. An example method includes transitioning, during a run-time of a wireless device, from operating according to a first transmit scenario with a first set of antenna groups for a plurality of transmit antennas to operating according to a second transmit scenario with a second set of antenna groups, while maintaining compliance with an RF exposure limit across the transition. The transitioning includes determining the second set of antenna groups, such that an RF exposure history associated with the first set of antenna groups for the plurality of transmit antennas is maintained for the second set of antenna groups across the transition. The method also includes transmitting, from at least one transmit antenna in the second set of antenna groups, while operating according to the second transmit scenario.

### CROSS-REFERENCE TO RELATED APPLICATION(S)

This application claims priority to and benefit of U.S. Patent Application No. 63/727,498, filed Dec. 3, 2024, and U.S. Provisional Application No. 63/671,628, filed Jul. 15, 2024, which are both assigned to the assignee hereof and hereby expressly incorporated by reference in their entireties as if fully set forth below and for all applicable purposes.

### INTRODUCTION

### Field of the Disclosure

Aspects of the present disclosure relate to wireless communications, and more particularly, to radio frequency (RF) exposure compliance across antenna grouping transitions.

### DESCRIPTION OF RELATED ART

Wireless communication systems are widely deployed to provide various telecommunication services such as telephony, video, data, messaging, broadcasts, etc. Modern wireless communication devices (such as cellular telephones) are generally mandated to meet radio frequency (RF) exposure limits set by certain governments and international standards and regulations. To ensure compliance with the standards, such devices currently undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly to comply with the RF exposure limit.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance.

Certain aspects of the subject matter described in this disclosure can be implemented in a method for wireless communication. The method generally includes transitioning, during a run-time of the wireless device, from operating according to a first transmit scenario with a first set of antenna groups for a plurality of transmit antennas to operating according to a second transmit scenario with a second set of antenna groups, while maintaining compliance with a radio frequency (RF) exposure limit across the transition. The transitioning includes determining the second set of antenna groups, such that an RF exposure history associated with the first set of antenna groups for the plurality of transmit antennas is maintained for the second set of antenna groups across the transition. The method also includes transmitting, from at least one transmit antenna in the second set of antenna groups, while operating according to the second transmit scenario.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to: transition, during a run-time of the apparatus, from operating according to a first transmit scenario with a first set of antenna groups for a plurality of transmit antennas to operating according to a second transmit scenario with a second set of antenna groups, while maintaining compliance with a radio frequency (RF) exposure limit across the transition, wherein to transition to operating according to the second transmit scenario, the one or more processors are collectively configured to execute the executable instructions to cause the apparatus to determine the second set of antenna groups, such that an RF exposure history associated with the first set of antenna groups for the plurality of transmit antennas is maintained for the second set of antenna groups across the transition; and transmit, from at least one transmit antenna in the second set of antenna groups, while operating according to the second transmit scenario.

Certain aspects of the subject matter described in this disclosure can be implemented in an apparatus for wireless communication. The apparatus generally includes means for transitioning, during a run-time of the apparatus, from operating according to a first transmit scenario with a first set of antenna groups for a plurality of transmit antennas to operating according to a second transmit scenario with a second set of antenna groups, while maintaining compliance with a radio frequency (RF) exposure limit across the transition. The means for transitioning includes means for determining the second set of antenna groups, such that an RF exposure history associated with the first set of antenna groups for the plurality of transmit antennas is maintained for the second set of antenna groups across the transition. The apparatus also includes means for transmitting, from at least one transmit antenna in the second set of antenna groups, while operating according to the second transmit scenario.

Certain aspects of the subject matter described in this disclosure can be implemented in a computer-readable medium. The computer-readable medium has instructions stored thereon for performing an operation. The operation includes transitioning, during a run-time of a wireless device, from operating according to a first transmit scenario with a first set of antenna groups for a plurality of transmit antennas to operating according to a second transmit scenario with a second set of antenna groups, while maintaining compliance with a radio frequency (RF) exposure limit across the transition. The operation also includes transmitting, from at least one transmit antenna in the second set of antenna groups, while operating according to the second transmit scenario.

Certain aspects of the subject matter described in this disclosure can be implemented in a method for wireless communication. The method generally includes determining, from a plurality of transmit scenarios supported by the wireless device, a transmit scenario that the wireless device is operating with at a point in time. The method also includes determining a set of antenna groups for a first set of transmit antennas, based on the transmit scenario. The method further includes transmitting, from at least one transmit antenna in the set of antenna groups, according to the transmit scenario.

Certain aspects of the subject matter described in this disclosure can be implemented in an apparatus for wireless communication. The apparatus includes one or more memories collectively storing executable instructions, and one or more processors coupled to the one or more memories. The one or more processors are collectively configured to execute the executable instructions to cause the apparatus to: determine, from a plurality of transmit scenarios supported by the apparatus, a transmit scenario that the apparatus is operating with at a point in time; determine a set of antenna groups for a first set of transmit antennas, based on the transmit scenario; and transmit, from at least one transmit antenna in the set of antenna groups, according to the transmit scenario.

Certain aspects of the subject matter described in this disclosure can be implemented in an apparatus for wireless communication. The apparatus generally includes means for determining, from a plurality of transmit scenarios supported by the apparatus, a transmit scenario that the apparatus is operating with at a point in time. The apparatus also includes means for determining a set of antenna groups for a first set of transmit antennas, based on the transmit scenario. The apparatus further includes means for transmitting, from at least one transmit antenna in the set of antenna groups, according to the transmit scenario.

Certain aspects of the subject matter described in this disclosure can be implemented in a computer-readable medium. The computer-readable medium has instructions stored thereon for performing an operation. The operation generally includes determining, from a plurality of transmit scenarios supported by a wireless device, a transmit scenario that the wireless device is operating with at a point in time. The operation also includes determining a set of antenna groups for a first set of transmit antennas, based on the transmit scenario. The operation further includes transmitting, from at least one transmit antenna in the set of antenna groups, according to the transmit scenario.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication system exhibiting radio frequency (RF) exposure to a human, in accordance with certain aspects of the present disclosure.

FIG. 2 is a block diagram conceptually illustrating a design of an example wireless communication device communicating with another device, in accordance with certain aspects of the present disclosure.

FIG. 3 is a diagram illustrating an example of a normalized specific absorption rate (SAR) distribution combined with a normalized power density (PD) distribution, in accordance with certain aspects of the present disclosure.

FIG. 4 is a graph illustrating examples of transmit powers over time in compliance with an RF exposure limit, in accordance with certain aspects of the present disclosure.

FIG. 5 is a diagram illustrating an example system for measuring RF exposure values, in accordance with certain aspects of the present disclosure.

FIG. 6 is a flow diagram illustrating example operations for grouping antennas for RF exposure compliance by a wireless device, in accordance with certain aspects of the present disclosure.

FIG. 7 is a block diagram illustrating an example grouping of multiple antennas of a wireless communication device, in accordance with certain aspects of the present disclosure.

FIG. 8 is a flow diagram illustrating example operations for determining backoff factors for antenna groups, in accordance with certain aspects of the present disclosure.

FIG. 9 is a flow diagram illustrating example operations for assigning antennas to groups based on the backoff factors, in accordance with certain aspects of the present disclosure.

FIG. 10 is a flow diagram illustrating example operations for wireless communication by a wireless device, in accordance with certain aspects of the present disclosure.

FIG. 11 illustrates a diagram of example locations of a wireless device relative to a body of a user, in accordance with certain aspects of the present disclosure.

FIG. 12 is a flow diagram illustrating example operations for wireless communication by a wireless device, in accordance with certain aspects of the present disclosure.

FIG. 13 is a flow diagram illustrating example operations for wireless communication by a wireless device, in accordance with certain aspects of the present disclosure.

FIG. 14 illustrates a communications device (e.g., a user equipment (UE)) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for complying with radio frequency (RF) exposure limits across transitions between different transmit scenarios and antenna groupings during operation (e.g., run-time) of a wireless device. In certain aspects, the wireless device, in real-time, determines, generates, and/or operates with antenna groupings per one or more transmit scenarios in compliance with RF exposure limits (e.g., time-averaged RF exposure limits).

Antenna groups may be defined and/or operated so as to be mutually exclusive in terms of RF exposure. That is, the RF exposure compliance (e.g., time-averaged RF exposure compliance) and corresponding transmit power levels may be determined separately for each antenna group. In certain cases, antennas may be grouped, for example, using backoff factors to determine an antenna grouping (also referred to herein as a “set of antenna groups”). Additionally or alternatively, in certain cases, backoff factors may be used to maintain RF exposure exclusivity among antenna groups. In certain cases, antenna groups/groupings may also be developed or defined without use of or reference to backoff factors. The antenna-group-based RF exposure compliance described herein may enable desirable transmit power for specific antenna groups, for example, due to differing exposure scenarios (or, more generally, transmit scenarios) encountered by each antenna group. The desirable transmit power may provide desirable uplink performance, such as desirable uplink data rates, uplink carrier aggregation, and/or an uplink connection at the edge of a cell.

Additionally, in certain cases, the wireless device may determine and/or operate with multiple antenna groupings (also referred to herein as “multiple sets of antenna groups”). The antenna groupings may be developed for different transmit scenarios. For example, a first antenna grouping of transmit antennas may be used for a first transmit scenario, a second antenna grouping of the transmit antennas may be used for a second transmit scenario, and so on. Each antenna grouping may have a respective (same or different) arrangement of transmit antennas. As used herein, a “transmit scenario” may correspond to various combinations of radios, communication technologies (e.g., radio access technologies (RATs)), transmit antennas, transmit antenna configurations, operating conditions (or modes), frequency bands (including transmit frequency band), RF exposure scenarios (e.g., head exposure, body-worn exposure, extremity (hand) exposure, and/or hotspot exposure, including device state such as open vs. closed state for foldable devices), device use-case scenarios (e.g., based on active applications on the device such as voice vs. data applications, gaming vs. video-call applications active on the device), and/or geographical locations or regions (e.g., country or region, such as the United States, China, and the European Union, among others), as illustrative, non-limiting examples.

Antenna groupings per transmit scenario may provide flexibility for a wireless device to switch between antenna groupings depending on the transmit scenario encountered by the wireless device. In certain scenarios, for example, a wireless device, during run-time, may transition between operating according to different transmit scenarios over time, such as transitioning from a first country or region (e.g., the United States) to a second country or region (e.g., China or the European Union), transitioning from a first exposure scenario (e.g., head exposure) to a second exposure scenario (e.g., body exposure), transitioning from a first device state to a second device state, transitioning from a first use case (e.g., first set of application(s) active on device) to a second use case (e.g., second set of applications active on the device), transitioning from a first operating condition (or mode) (e.g., single-input, single-output (SISO) transmission) to a second operating condition (or mode) (e.g., multiple-input, multiple-output (MIMO) transmission), or any combination thereof, as illustrative, non-limiting examples. In such scenarios, the wireless device, during run-time, may switch between antenna groupings depending on the transmit scenario encountered by the wireless device (e.g., switching from a first antenna grouping for a first transmit scenario to a second antenna grouping for a second transmit scenario).

One potential drawback to switching between antenna groupings is that, in certain scenarios, the switching may cause the wireless device to violate RF exposure compliance (e.g., time-averaged RF exposure compliance). For example, the wireless device may evaluate a time-averaged RF exposure separately for each transmit scenario over a time window. That is, the RF exposure for each transmit scenario may be tracked and/or assessed separately for each transmit scenario over a time window, and RF exposure time averaging may be performed separately per transmit scenario. Further, even in configurations where transmit scenarios are not tracked separately, RF exposure compliance may be violated if previous RF exposure from certain antennas or antenna groups is not appropriately considered during subsequent transmit scenarios. For example, in cases where the wireless device transitions between antenna groupings over the time window without maintaining the RF exposure history from the previous antenna grouping across the transition, the transition may cause the wireless device to violate the time-averaged RF exposure compliance.

Certain aspects of the present disclosure provide apparatus and methods for providing RF exposure compliance (e.g., time-averaged RF exposure compliance) across transitions between different antenna groupings during a wireless device's run-time operation. In certain aspects, the wireless device may determine, generate, and/or transition between antenna groupings in real-time for a given transition in a transmit scenario in a manner that maintains compliance with a time-averaged RF exposure limit across the antenna grouping transition(s). For example, as antenna groupings change in real-time for a given transmit scenario transition, the wireless device may perform a time-averaged RF exposure operation for each updated antenna grouping (having an updated arrangement of transmit antennas), such that device-level time-averaged RF exposure compliance continuity is maintained across the transmit scenario/antenna grouping transitions.

The apparatus and methods for providing RF exposure compliance across antenna grouping transitions may provide various advantages. For example, transitioning between antenna groupings in real-time while maintaining compliance with an RF exposure limit (e.g., time-averaged RF exposure limit) across the transition(s) may allow the wireless device to avoid violations of RF exposure compliance, to improve wireless communication performance (e.g., increased throughput, decreased latency, and/or increased transmission range), or combinations thereof.

The following description provides examples of RF exposure compliance, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a channel, a tone, a subband, etc. Each frequency may support a single RAT in a given geographic area in order to avoid interference between wireless networks of different RATs, or may support multiple RATs.

As used herein, a radio may refer to a physical or logical transmission path associated with one or more frequency bands (carriers, channels, bandwidths, subdivisions thereof, etc.), transmitters (or transceivers), and/or RATs (e.g., wireless wide area network (WWAN), wireless local area network (WLAN), short-range communications (e.g., Bluetooth), non-terrestrial communications, device-to-device (D2D) communications, vehicle-to-everything (V2X) communications, etc.) used for wireless communications. For example, for uplink carrier aggregation (or multi-connectivity) in WWAN, each of the active component carriers used for wireless communications may be treated as a separate radio. Similarly, multi-band transmissions for Institute of Electrical and Electronics Engineers (IEEE) 802.11 may be treated as separate radios for each frequency band (e.g., 2.4 gigahertz (GHz), 5 GHZ, and/or 6 GHZ). In some examples, a radio is defined based on a RAT and/or frequency for the purposes of RF exposure determination and/or RF exposure compliance.

The techniques described herein may be used for various wireless networks and radio technologies. While aspects may be described herein using terminology commonly associated with 3G, 4G, and/or 5G (e.g., 5G New Radio (NR)) wireless technologies, aspects of the present disclosure can be applied in other generation-based communication systems and/or to wireless technologies such as IEEE 802.11, 802.15, etc.

Although the terms “first,” “second,” “third,” etc., may be used herein to describe various devices, elements, components, regions, layers and/or sections, these devices, elements, components, regions, layers, and/or sections should not be limited by these terms. These terms may be only used to distinguish one device, element, component, region, layer or section from another device, element, component, region, layer, or section. Terms such as “first,” “second,” and other numerical terms, when used herein, do not imply a sequence or order unless clearly indicated by the context. Thus, a first device, element, component, region, layer, or section discussed herein could be termed a second device, element, component, region, layer, or section without departing from the scope of the present disclosure.

### Example Wireless Communication Network and Devices

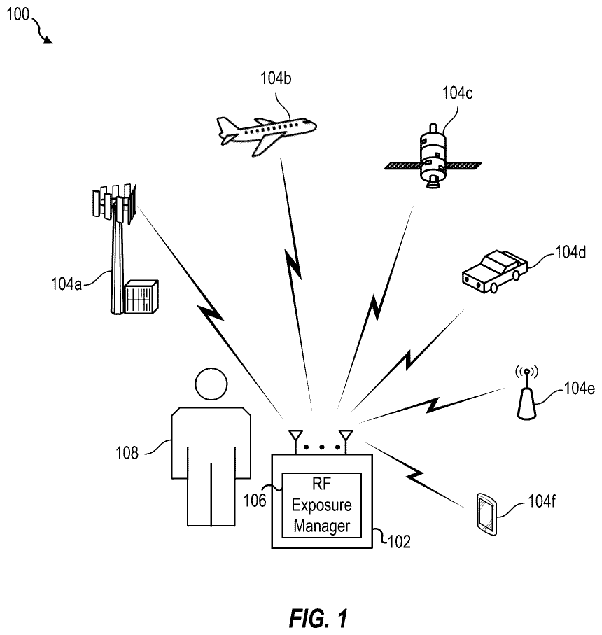

FIG. 1 illustrates an example wireless communication system 100 in which aspects of the present disclosure may be performed. For example, the wireless communication system 100 may include a WWAN and/or a WLAN. For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G)/Third Generation (3G) network), a code division multiple access (CDMA) system (e.g., a 2G/3G network), any future WWAN system, or any combination thereof. A WLAN may include a wireless network configured for communications according to an IEEE standard such as one or more of the 802.11 standards, etc. In some cases, the wireless communication system 100 may include a D2D communications network or a short-range communications system, such as Bluetooth communications.

As illustrated in FIG. 1, the wireless communication system 100 may include a wireless device 102 communicating with any of various wireless devices 104a-104f (a wireless device 104) via any of various RATs, where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The wireless device 102 may be emitting RF signals in proximity to a human 108, who may be the user of the wireless device 102 and/or a bystander. As an example, the wireless device 102 may be held in the hand of the human 108 and/or positioned against or near the head of the human 108. In certain cases, the wireless device 102 may be positioned in a pocket or bag of the human 108. In some cases, the wireless device 102 may positioned proximate to the human 108 as a mobile hotspot. To ensure the human 108 is not overexposed to RF emissions from the wireless device 102, the wireless device 102 may control the transmit power associated with the RF signals in accordance with an RF exposure limit, as further described herein, where the RF exposure limit may depend on the corresponding exposure scenario (e.g., head exposure, hand (extremity) exposure, body (body-worn) exposure, hotspot exposure, etc.).

The wireless device 102 may include any of various wireless communication devices including a user equipment (UE), a wireless station, an access point, a customer-premises equipment (CPE), etc. In certain aspects, the wireless device 102 includes an RF exposure manager 106 that manages the RF exposure associated with one or more radios in compliance with an RF exposure limit, in accordance with aspects of the present disclosure. The RF exposure manager 106 may enforce RF exposure compliance (e.g., maintain time-averaged RF exposure compliance) across transitions between different transmit scenarios/antenna groupings during run-time operation of the wireless device 102, in accordance with aspects of the present disclosure.

The wireless devices 104a-104f may include, for example, a base station 104a, an aircraft 104b, a satellite 104c, a vehicle 104d, an access point 104c, and/or a UE 104f. Further, the wireless communication system 100 may include terrestrial aspects, such as ground-based network entities (e.g., the base station 104a and/or access point 104c), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB (NB), enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always-on (AON) devices, edge processing devices, or other similar devices. A UE may also be referred to more generally as a mobile device, a wireless device, a wireless communications device, a station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. Frequency bands of 24 GHz to 71 GHz are sometimes referred to as a “millimeter wave” (“mmW” or “mmWave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.1 lay, 5G in mmWave bands, etc. Thus, different metrics may be used to assess RF exposure for different wireless communication technologies.

A wireless device (e.g., the wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHZ (e.g., 3G, 4G, 5G, 802.11a/b/g/n/ac, etc.) and a second wireless communication technology operating above 6 GHZ (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD. As used herein, sub-6 GHz bands may include frequency bands of 300 megahertz (MHz) to 6,000 MHz in some examples, and may include bands in the 6,000 MHz and/or 7,000 MHz range in some examples.

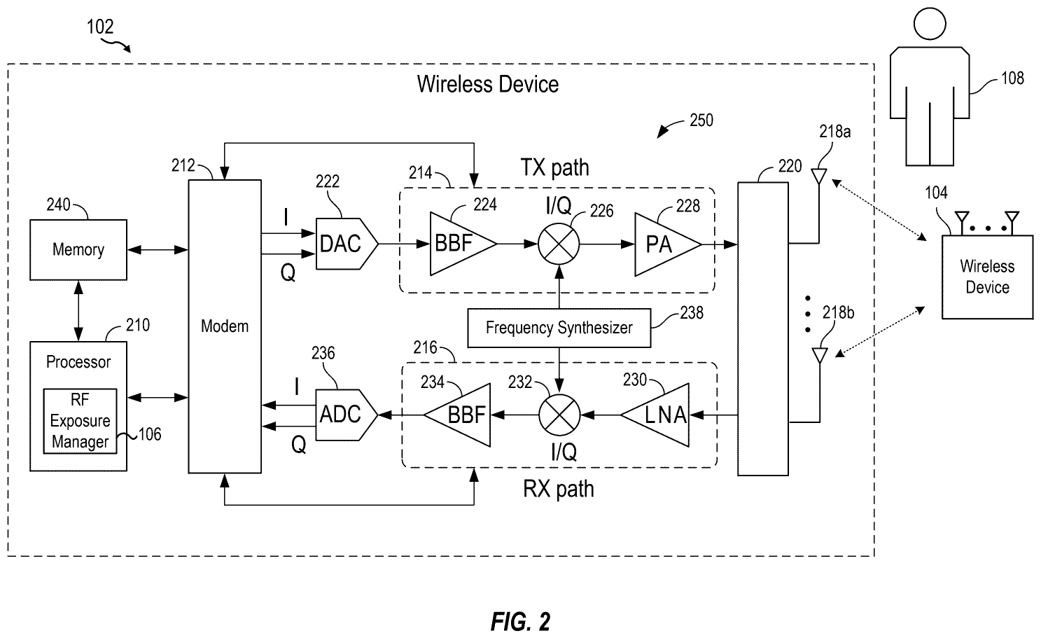

FIG. 2 illustrates example components of the wireless device 102, which may be used to communicate with any of the wireless devices 104, in some cases, in proximity to human tissue as represented by the human 108.

The wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the wireless device 102 also includes one or more radios (collectively “the radio(s) 250”). In some aspects, the wireless device 102 further includes one or more processors, processing blocks, or processing elements (collectively “the processor 210”) and one or more memory blocks or elements (collectively “the memory 240”).

In certain aspects, the processor 210 may include a processor that is representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a RAT. For example, the processor 210 may process any of an application layer, packet layer, WLAN protocol stack layers (e.g., a link or MAC layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an intelligent hardware block or device such as an application-specific integrated circuit (ASIC), among other possibilities. The modem 212 may generally be configured to implement a physical (PHY) layer. For example, the modem 212 may be configured to modulate packets and to output the modulated packets to the radio(s) 250 for transmission over a wireless medium. The modem 212 is similarly configured to obtain modulated packets received by the radio(s) 250 and to demodulate the packets to provide demodulated packets. In addition to a modulator and a demodulator, the modem 212 may further include digital signal processing (DSP) circuitry, automatic gain control (AGC), a coder, a decoder, a multiplexer, and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio(s) 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to a DAC 222.

Receiving I or Q baseband analog signals from the DAC 222, the TX path 214 may include a baseband filter (BBF) 224, a mixer 226, and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 314 are typically RF signals, which may be amplified by the PA 228 before transmission by the antenna(s) 218. The antenna(s) 218 may emit RF signals, which may be received at the wireless device 104. While one mixer 226 is illustrated, several mixers may be used to upconvert the filtered baseband signals to one or more intermediate frequencies and to thereafter upconvert the intermediate frequency signals to a frequency for transmission.

In some cases, the wireless device 102 may communicate via multiple-input, multiple-output (MIMO) signals. The wireless device 102 may transmit more than one signal via multiple antennas 218a, 218b (collectively “the antennas 218”) to the wireless device 104 through multipath propagation. As an example, a first signal may be transmitted via a first antenna 218a, and a second signal may be transmitted via a second antenna 218b via a different propagation path than the first signal. The MIMO signals may facilitate increased communication link capacity (e.g., throughput) between the wireless device 102 and the wireless device 104.

The RX path 216 may include a low noise amplifier (LNA) 230, a mixer 232, and a baseband filter (BBF) 234. RF signals received via the antenna 218 (e.g., from the wireless device 104) may be amplified by the LNA 230, and the mixer 232 (which may comprise one or several mixers) mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals (e.g., demodulating the digital signals).

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with the methods described herein. The processor 210 and/or the modem 212 may include a microcontroller, a microprocessor, an application processor, a baseband processor, a MAC processor, a neural network processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. The memory 240 may store data and program codes (e.g., computer-readable instructions) for performing wireless communications as described herein. The memory 240 may be external to the processor 210 and/or the modem 212 (as illustrated) and/or incorporated therein.

In certain cases, the RF exposure manager 106 (as implemented via the processor 210 and/or modem 212) may enforce RF exposure compliance (e.g., maintain time-averaged RF exposure compliance) across transitions between different transmit scenarios/antenna groupings during run-time operation of the wireless device 102, as described herein.

FIG. 2 shows one reference example of a transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example RF Exposures

As noted, RF exposure may be expressed in terms of SAR and/or PD. As also noted, a wireless device (e.g., the wireless device 102) may be capable of transmitting signals using multiple wireless communication technologies. For example, the wireless device may transmit signals using a first wireless communication technology (e.g., 3G, 4G, 5G in sub-6 GHz bands, IEEE 802.11ac, etc.) in which RF exposure may be measured in terms of SAR, and a second wireless communication technology (e.g., 5G in 24 to 71 GHz bands, IEEE 802.11ad, 802.11ay, etc.) in which RF exposure may be measured in terms of PD.

To assess RF exposure from transmissions using the first technology (e.g., 3G, 4G, 5G in sub-6 GHz bands, IEEE 802.11ac, etc.), the wireless device may include multiple SAR values and/or distributions for the first technology stored in memory (e.g., memory 240 of FIG. 2). Each of the SAR values and/or distributions may correspond to a respective one of multiple transmit scenarios supported by the wireless device for the first technology. The transmit scenarios may correspond to various combinations of radios (e.g., radio(s) 250 of FIG. 2), communication technologies (e.g., RAT(s)), antennas (e.g., antenna(s) 218 of FIG. 2), antenna configurations, operating conditions (or modes), frequency bands, RF exposure scenarios (e.g., head exposure, body-worn exposure, extremity (hand) exposure, and/or hotspot exposure), and/or geographical locations or regions (e.g., countries or regions), as discussed further below. In some examples, the stored SAR includes a single value (e.g., a peak value determined based on the description below, or a sum of peak values).

The SAR values and/or distribution (also referred to as a SAR map) for each transmit scenario may be generated based on measurements (e.g., E-field measurements) performed in a test laboratory using a model of a human body. After generation, the SAR values are stored in the memory to enable a processor (e.g., processor 210 of FIG. 2) to assess RF exposure in real time, as discussed further below. Each SAR distribution may include a set of SAR values, where each SAR value may correspond to a different location (e.g., on the model of the human body). Each SAR value may comprise a SAR value averaged over a mass of 1 g or 10 g at the respective location.

The SAR values in each SAR distribution correspond to a particular transmission power level (e.g., the transmission power level at which the SAR values were measured in the test laboratory). Since SAR scales with transmission power level, the processor may scale a SAR value or distribution for any transmission power level by multiplying each SAR value (e.g., in the SAR distribution) by the following transmission power scaler:

$$\frac{{Tx}_{c}}{{Tx}_{SAR}} \qquad ( 1 )$$

where Tx_{c} is a current transmission power level for the respective transmit scenario, and Tx_{SAR} is the transmission power level corresponding to the SAR values (e.g., the transmission power level at which the SAR values were measured in the test laboratory).

As discussed above, the wireless communication device may support multiple transmit scenarios for the first technology. In certain aspects, the transmit scenarios may be specified by a set of parameters. The set of parameters may include, without limitation, one or more of the following: a radio parameter indicating one or more radios used for transmission (i.e., active radios), an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a device state index (DSI)) indicating the location of the wireless communication device relative to the user's body location (head, trunk, away from the body, etc.), exposure category, a parameter indicating a geographical location or region (e.g., public land mobile network (PLMN) code and/or a mobile country code (MCC)), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate SAR values and/or distributions for the subset of transmit scenarios. In this example, the SAR values and/or distributions for each of the remaining transmit scenarios may be generated by combining two or more of the SAR values and/or distributions for the subset of transmit scenarios, as discussed further below.

For example, SAR measurements may be performed for each one of the antennas to generate a SAR value or distribution for each one of the antennas. In this example, a SAR value or distribution for a transmit scenario in which two or more of the antennas are active may be generated by combining the SAR values or distributions for the two or more active antennas.

In another example, SAR measurements may be performed for each one of multiple frequency bands to generate a SAR value or distribution for each one of the multiple frequency bands. In this example, a SAR value or distribution for a transmit scenario in which two or more frequency bands are active may be generated by combining the SAR values or distributions for the two or more active frequency bands.

In certain aspects, a SAR distribution may be normalized with respect to a SAR limit by dividing each SAR value in the SAR distribution by the SAR limit. In this case, a normalized SAR value exceeds the SAR limit when the normalized SAR value is greater than one, and is below the SAR limit when the normalized SAR value is less than one. In these aspects, each of the SAR distributions stored in the memory may be normalized with respect to a SAR limit. Similarly, a single or individual SAR value may be normalized with respect to a SAR limit.

In certain aspects, the normalized SAR value or distribution for a transmit scenario may be generated by combining two or more normalized values or SAR distributions. For example, a normalized SAR value or distribution for a transmit scenario in which two or more antennas are active may be generated by combining the normalized SAR values or distributions for the two or more active antennas. For the case in which different transmission power levels are used for the active antennas, the normalized SAR value or distribution for each active antenna may be scaled by the respective transmission power level before combining the normalized SAR values or distributions for the active antennas. The normalized SAR value or distribution for simultaneous transmission from multiple active antennas may be given by the following:

$${SAR}_{norm \_ combined} = {\sum }_{i = 1}^{i = K} \frac{{Tx}_{i}}{{Tx}_{SARi}} \cdot \frac{{SAR}_{i}}{{SAR}_{li m}} \qquad ( 2 )$$

where SARₗᵢₘ is a SAR limit, SAR_{norm_combined} is the combined normalized SAR value or distribution for simultaneous transmission from the active antennas, i is an index for the active antennas, SARᵢ is the SAR value or distribution for the i^{th} active antenna, Txᵢ is the transmission power level for the i^{th} active antenna, Tx_{SARi} is the transmission power level for the SAR distribution for the i^{th} active antenna, and K is the number of the active antennas.

Equation (2) may be rewritten as follows:

$${SAR}_{norm \_ combined} = {\sum }_{i = 1}^{i = K} \frac{{Tx}_{i}}{{Tx}_{SARi}} \cdot {SAR}_{norm \_ i} \qquad ( 3 a )$$

where SAR_{norm_i} is the normalized SAR value or distribution for the i^{th} active antenna. In the case of simultaneous transmissions using multiple active antennas at the same transmitting frequency (e.g., multiple input, multiple output (MIMO)), the combined normalized SAR value or distribution may be obtained by summing the square root of the individual normalized SAR values or distributions and computing the square of the sum, as given by the following:

$$S A {R}_{norm \_ combined \_ MIMO} = {[ {\sum }_{i = 1}^{i = K} \sqrt{\frac{{Tx}_{i}}{{Tx}_{SARi}} \cdot {SAR}_{norm \_ i}} ]}^{2} . \qquad ( 3 b )$$

In another example, normalized SAR values or distributions for different frequency bands may be stored in the memory. In this example, a normalized SAR distribution for a transmit scenario in which two or more frequency bands are active may be generated by combining the normalized SAR distributions for the two or more active frequency bands. For the case where the transmission power levels are different for the active frequency bands, the normalized SAR value or distribution for each of the active frequency bands may be scaled by the respective transmission power level before combining the normalized SAR values or distributions for the active frequency bands. In this example, the combined SAR value or distribution may also be computed using Equation (3a) in which i is an index for the active frequency bands, SAR_{norm_i} is the normalized SAR value or distribution for the i^{th} active frequency band, Txᵢ is the transmission power level for the i^{th} active frequency band, and Tx_{SARi} is the transmission power level for the normalized SAR value or distribution for the i^{th} active frequency band.

To assess RF exposure from transmissions using the second technology (e.g., 5G in 24 to 60 GHz bands, IEEE 802.11ad, 802.11ay, etc.), the wireless device may include multiple PD values and/or distributions for the second technology stored in the memory (e.g., memory 240 of FIG. 2). Each of the PD values or distributions may correspond to a respective one of multiple transmit scenarios supported by the wireless device for the second technology. The transmit scenarios may correspond to various combinations of radios (e.g., radio(s) 250 of FIG. 2), communication technologies (e.g., RAT(s)), antennas (e.g., antenna(s) 218 of FIG. 2), antenna configurations, operating conditions (or modes), frequency bands, RF exposure scenarios (e.g., head exposure, body-worn exposure, extremity (hand) exposure, and/or hotspot exposure), and/or geographical locations or regions (e.g., countries or regions), as discussed further below. In some examples, the stored PD includes a single value (e.g., a peak value determined based on the description below, or a sum of peak values).

The PD values and/or distribution (also referred to as PD map) for each transmit scenario may be generated based on measurements (e.g., E-field measurements) performed in a test laboratory using a model of a human body. After generation, the PD values are stored in the memory to enable the processor (e.g., processor 210 of FIG. 2) to assess RF exposure in real time, as discussed further below. Each PD distribution may include a set of PD values, where each PD value may correspond to a different location (e.g., on the model of the human body).

The PD values in each PD distribution correspond to a particular transmission power level (e.g., the transmission power level at which the PD values were measured in the test laboratory). Since PD scales with transmission power level, the processor may scale a PD value or distribution for any transmission power level by multiplying each PD value (e.g., in the PD distribution) by the following transmission power scaler:

$$\frac{{Tx}_{c}}{{Tx}_{PD}} \qquad ( 4 )$$

where Tx_{c} is a current transmission power level for the respective transmit scenario, and Tx_{PD} is the transmission power level corresponding to the PD values (e.g., the transmission power level at which the PD values were measured in the test laboratory).

As discussed above, the wireless communication device may support multiple transmit scenarios for the second technology. In certain aspects, the transmit scenarios may be specified by a set of parameters. The set of parameters may include, without limitation, one or more of the following: a radio parameter indicating one or more radios used for transmission (i.e., active radios), an antenna parameter indicating one or more antennas used for transmission (i.e., active antennas), a frequency band parameter indicating one or more frequency bands used for transmission (i.e., active frequency bands), a channel parameter indicating one or more channels used for transmission (i.e., active channels), a body position parameter (e.g., a DSI) indicating the location of the wireless communication device relative to the user's body location (head, trunk, away from the body, etc.), exposure category, a parameter indicating a geographical location or region (e.g., PLMN code and/or a MCC), and/or other parameters. In cases where the wireless device supports a large number of transmit scenarios, it may be very time-consuming and expensive to perform measurements for each transmit scenario in a test setting (e.g., test laboratory). To reduce test time, measurements may be performed for a subset of the transmit scenarios to generate PD values and/or distributions for the subset of transmit scenarios. In this example, the PD values and/or distributions for each of the remaining transmit scenarios may be generated by combining two or more of the PD values and/or distributions for the subset of transmit scenarios, as discussed further below.

For example, PD measurements may be performed for each one of the antennas to generate a PD value or distribution for each one of the antennas. In this example, a PD value or distribution for a transmit scenario in which two or more of the antennas are active may be generated by combining the PD values or distributions for the two or more active antennas.

In another example, PD measurements may be performed for each one of multiple frequency bands to generate a PD value or distribution for each one of the multiple frequency bands. In this example, a PD value or distribution for a transmit scenario in which two or more frequency bands are active may be generated by combining the PD values or distributions for the two or more active frequency bands.

In certain aspects, a PD distribution may be normalized with respect to a PD limit by dividing each PD value in the PD distribution by the PD limit. In this case, a normalized PD value exceeds the PD limit when the normalized PD value is greater than one, and is below the PD limit when the normalized PD value is less than one. In these aspects, each of the PD distributions stored in the memory may be normalized with respect to a PD limit. Similarly, a single or individual PD value may be normalized with respect to a PD limit.

In certain aspects, the normalized PD value or distribution for a transmit scenario may be generated by combining two or more normalized PD values or distributions. For example, a normalized PD value or distribution for a transmit scenario in which two or more antennas are active may be generated by combining the normalized PD values or distributions for the two or more active antennas. For the case in which different transmission power levels are used for the active antennas, the normalized PD value or distribution for each active antenna may be scaled by the respective transmission power level before combining the normalized PD values or distributions for the active antennas. The normalized PD value or distribution for simultaneous transmission from multiple active antennas may be given by the following:

$${PD}_{norm \_ combined} = {\sum }_{i = 1}^{i = L} \frac{{Tx}_{i}}{{Tx}_{PDi}} \cdot \frac{{PD}_{i}}{P {D}_{li m}} \qquad ( 5 )$$

where PDₗᵢₘ is a PD limit, PD_{norm_combined} is the combined normalized PD value or distribution for simultaneous transmission from the active antennas, i is an index for the active antennas, PD; is the PD value or distribution for the i^{th} active antenna, Txᵢ is the transmission power level for the i^{th} active antenna, Tx_{PDi} is the transmission power level for the PD distribution for the i^{th} active antenna, and L is the number of the active antennas.

Equation (5) may be rewritten as follows:

$${PD}_{norm \_ combined} = {\sum }_{i = 1}^{i = L} \frac{{Tx}_{i}}{{Tx}_{PDi}} \cdot {PD}_{norm \_ i} \qquad ( 6 a )$$

where PD_{norm_i} is the normalized PD value or distribution for the i^{th} active antenna. In the case of simultaneous transmissions using multiple active antennas at the same transmitting frequency (e.g., MIMO), the combined normalized PD value or distribution may be obtained by summing the square root of the individual normalized PD values or distributions and computing the square of the sum, as given by the following:

$$P {D}_{norm \_ combined \_ MIMO} = {[ {\sum }_{i = 1}^{i = L} \sqrt{\frac{{Tx}_{i}}{{Tx}_{PDi}} \cdot {PD}_{norm \_ i}} ]}^{2} . \qquad ( 6 b )$$

In another example, normalized PD values or distributions for different frequency bands may be stored in the memory. In this example, a normalized PD value or distribution for a transmit scenario in which two or more frequency bands are active may be generated by combining the normalized PD distributions for the two or more active frequency bands. For the case where the transmission power levels are different for the active frequency bands, the normalized PD value or distribution for each of the active frequency bands may be scaled by the respective transmission power level before combining the normalized PD values or distributions for the active frequency bands. In this example, the combined PD value or distribution may also be computed using Equation (6a) in which i is an index for the active frequency bands, PD_{nom_i} is the normalized PD value or distribution for the i^{th} active frequency band, Txᵢ is the transmission power level for the i^{th} active frequency band, and Tx_{PDi} is the transmission power level for the normalized PD value or distribution for the i^{th} active frequency band.

### Example RF Exposure Combination

As discussed above, a wireless device (e.g., the wireless device 102) may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). In this case, the wireless device may determine a first maximum allowable power level for the first technology and a second maximum allowable power level for the second technology for transmissions in a future time slot that comply with RF exposure limits. During the future time slot, the transmission power levels for the first and second technologies are constrained (i.e., bounded) by the determined first and second maximum allowable power levels, respectively, to ensure compliance with RF exposure limits, as further below. In the present disclosure, the term “maximum allowable power level” refers to a “maximum allowable power level” imposed by an RF exposure limit unless stated otherwise. It is to be appreciated that the “maximum allowable power level” is not necessarily equal to the absolute maximum power level that complies with an RF exposure limit and may be less than the absolute maximum power level that complies with the RF exposure limit (e.g., to provide a safety margin). The “maximum allowable power level” may be used to set a power level limit on a transmission at a transmitter such that the power level of the transmission is not allowed to exceed the “maximum allowable power level” to ensure RF exposure compliance. Certain examples below (in this section and in other sections) are described with respect to SAR and/or PD distributions. It will be appreciated, however, that a distribution may not be used and that individual SAR or PD values may be utilized in most such examples.

The wireless device may determine the first and second maximum allowable power levels as follows. The wireless device may determine a normalized SAR distribution for the first technology at a first transmission power level, determine a normalized PD distribution for the second technology at a second transmission power level, and combine the normalized SAR distribution and the normalized PD distribution to generate a combined normalized RF exposure distribution (referred to simply as a combined normalized distribution below). The value at each location in the combined normalized distribution may be determined by combining the normalized SAR value at the location with the normalized PD value at the location or another technique.

The wireless device may then determine whether the first and second transmission power levels comply with RF exposure limits by comparing the peak value in the combined normalized distribution with one. If the peak value is equal to or less than one (i.e., satisfies the condition ≤1), then the wireless device may determine that the first and second transmission power levels comply with RF exposure limits (e.g., SAR limit and PD limit) and use the first and second transmission power levels as the first and second maximum allowable power levels, respectively, during the future time slot. If the peak value is greater than one, then the wireless device may determine that the first and second transmission power levels do not comply with RF exposure limits. The condition for RF exposure compliance for simultaneous transmissions using the first and second technologies may be given by:

$${SAR}_{norm} + {PD}_{norm} \leq 1. \qquad ( 7 )$$

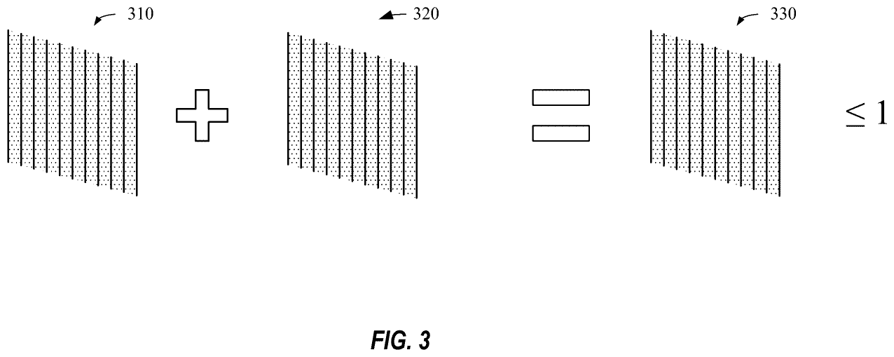

FIG. 3 is a diagram illustrating the normalized SAR distribution 310 and the normalized PD distribution 320, in which the normalized SAR distribution 310 and the normalized PD distribution 320 are combined to generate a combined normalized distribution 330. FIG. 3 also shows the condition that the peak value in the combined normalized distribution 330 be equal to or less than one for RF exposure compliance. Although each of the distributions 310, 320, and 330 is depicted as a two-dimensional distribution in FIG. 3, it is to be appreciated that the present disclosure is not limited to this example.

The normalized SAR distribution in Equation (7) may be generated by combining two or more normalized SAR distributions as discussed above (e.g., for a transmit scenario using multiple active antennas). Similarly, the normalized PD distribution in Equation (7) may be generated by combining two or more normalized PD distributions as discussed above (e.g., for a transmit scenario using multiple active antennas). In this case, the condition for RF exposure compliance in Equation (7) may be rewritten using Equations (3a) and (6a) as follows:

$${\sum }_{i = 1}^{i = K} \frac{{Tx}_{i}}{{Tx}_{SARi}} \cdot {SAR}_{norm \_ i} + {\sum }_{i = 1}^{i = L} \frac{{Tx}_{i}}{{Tx}_{PDi}} \cdot {PD}_{norm \_ i} \leq 1. \qquad ( 8 )$$

For the MIMO case, Equations (3b) and (6b) may be combined instead. As shown in Equation (8), the combined normalized distribution may be a function of transmission power levels for the first technology and transmission power levels for the second technology. All the points in the combined normalized distribution should meet the normalized limit of one in Equation (8). Additionally, when combining SAR and PD distributions, the SAR and PD distributions can be aligned spatially or aligned with their peak locations so that the combined distribution given by Equation (8) represents combined RF exposure for a given position of a human body.

### Example RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands).

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union, as illustrative examples. In some cases, the RF exposure limit(s) may specify the maximum allowed RF exposure that can be encountered without time averaging. In such cases, the maximum allowed RF exposure may correspond to a maximum output or transmit power that can be used by the wireless device.

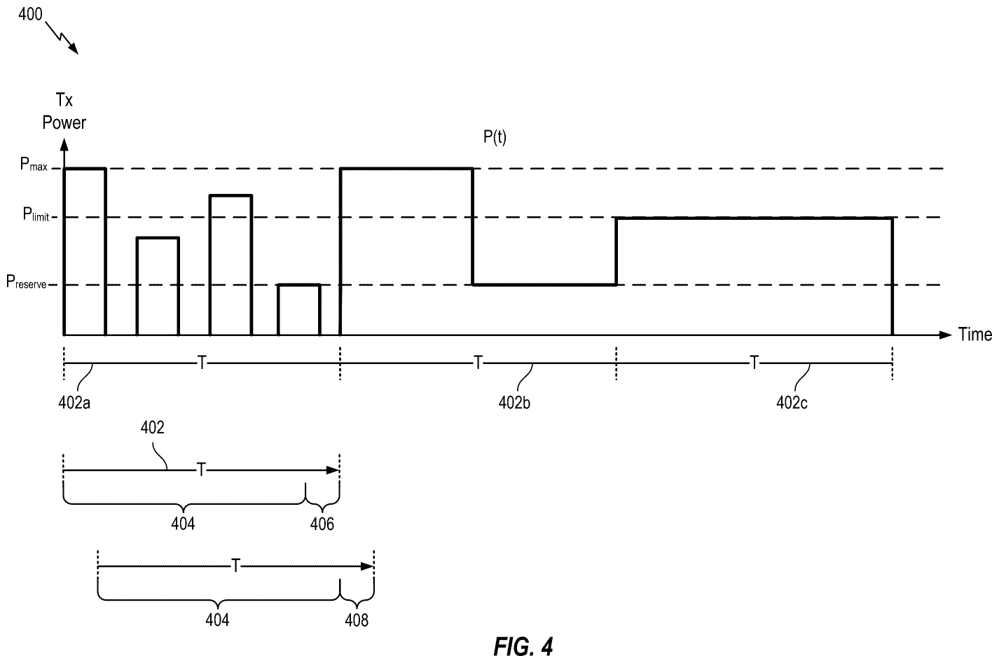

FIG. 4 is a graph 400 of a transmit power over time (P (t)) that varies over a running (e.g., rolling or moving) time window (T) associated with the RF exposure limit. The wireless device (e.g., the wireless device 102) may evaluate RF exposure compliance over the running time window 402 (T) based on past RF exposure (e.g., a transmit power report) in a past time interval 404 of the time window 402 and a future time interval 406. The wireless device may determine the maximum allowed transmit power for the future time interval 406 that satisfies the time-averaged RF exposure limit based on the past RF exposure used in the past time interval 404. The wireless device may perform such a time-averaging evaluation as the time window 402 moves over time, such as in the next future time interval 408, where the past time interval 404 now includes the previous future time interval 406.

The maximum time-averaged transmit power limit (Pₗᵢₘᵢₜ) represents the maximum transmit power the wireless device can transmit continuously for the duration of the running time window 402 (T) in compliance with the RF exposure limit. For example, the wireless device is transmitting continuously at Pₗᵢₘᵢₜ in the time window 402c such that the time-averaged transmit power over the time window (e.g., the time window 402c) is equal to Pₗᵢₘᵢₜ in compliance with the time-averaged RF exposure limit. The RF exposure level corresponding to time-averaged transmit power limit (Pₗᵢₘᵢₜ) may be referred to as an RF exposure design target. The RF exposure design target may be less than or equal to the RF exposure limit. The RF exposure design target may be selected to be less than the RF exposure limit to account for device uncertainty and/or to meet the RF exposure limit in exposure scenarios when transmitting simultaneously with other radios within the same device that have a different RF exposure controlling mechanism.

In certain cases, an instantaneous transmit power may exceed Pₗᵢₘᵢₜ in certain transmission occasions, for example, as shown in the time window 402a and the time window 402b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the time window 402a.

In certain cases, a reserve power may be used to enable a continuous transmission within a time window (T) when transmitting above Pₗᵢₘᵢₜ in the time window or to enable a certain level of quality for certain transmissions. As shown in the time window 402b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the time window 402c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling). Pᵣₑₛₑᵣᵥₑ may be used to reserve transmit power for at least a portion of the time window 402 for certain transmissions (e.g., control signaling). Pᵣₑₛₑᵣᵥₑ may also be referred to as a “control power level” or “control level.”

In the time window 402b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the area of transmit power (P(t)) in the time window 402b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the time window 402b. While a single transmit burst is illustrated in the time window 402b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 4), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 5 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. For example, in the time window 402a, the duty cycle may be greater than 50% of the duration of the time window (T), whereas in the time window 402b, the duty cycle may be equal to 100% of the duration of the time window (T).

In certain cases, the duty cycle may be standardized (e.g., predetermined) with a specific RAT and/or vary over time, for example, due to changes in radio conditions, mobility, and/or user behavior. As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example RF Exposure Measurements

In certain cases, the RF exposure of a wireless device may be certified with a regulatory agency (e.g., the FCC for the United States or the Innovation, Science and Economic Development Canada (ISED) for Canada). Spatial measurements may be taken with respect to a model (phantom) representing the human body, where the model may be filled with a liquid simulating human tissue. As discussed above, the first wireless device 102 may simultaneously transmit signals using the first technology (e.g., 3G, 4G, IEEE 802.11ac, etc.) and the second technology (e.g., 5G, IEEE 802.11ad, etc.), in which RF exposure is measured using different metrics for the first technology and the second technology (e.g., SAR for the first technology and PD for the second technology). The RF exposure measurements may be performed differently for each transmit scenario and include, for example, electric field measurements using a model of a human body. RF exposure values and/or distributions (simulation and/or measurement) may then be generated per transmit antenna/configuration (beam) on various evaluation surfaces/positions at various locations.

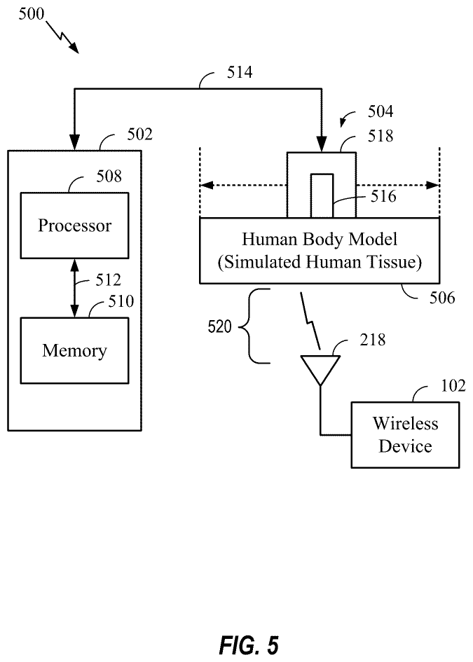

FIG. 5 is a diagram illustrating an example system 500 for measuring RF exposure levels (e.g., values and/or distributions) associated with a wireless communication device (e.g., the wireless device 102). As shown, the RF exposure measurement system 500 includes a processing system 502, a (robotic) RF probe 504, and a human body model 506. The RF exposure measurement system 500 may take RF measurements at various transmit scenarios. As used herein, a transmit scenario may correspond to various combinations of radios, communication technologies, antennas, antenna configurations, operating conditions (or modes) frequency bands, RF exposure scenarios (e.g., head exposure, body-worn exposure, extremity (hand) exposure, and/or hotspot exposure), and/or geographical locations or regions associated with the wireless device 102. In some examples, these measurements may be used to generate an RF exposure map and determine suitable transmit power limits for the transmit powers of the antenna(s) 218 in compliance with one or more RF exposure limits, as further described herein. The wireless device 102 may emit electromagnetic radiation via the antenna(s) 218 at various transmit powers, and the RF exposure measurement system 500 may take RF measurements via the robotic RF probe 504 (e.g., to determine RF exposure map(s) for the antenna(s) 218). Transmit power limits (e.g., Pₗᵢₘᵢₜ) for the various transmit scenarios associated with the wireless device 102 may be determined based on the RF measurements and/or exposure maps. Note that while measurements are described as being performed with respect to the wireless device 102, measurements may be taken with respect to a (different) representative device (e.g., a sample device for testing purposes), and then transmit power limits loaded into or otherwise provided or conveyed to the wireless device 102 (e.g., the devices manufactured for end-users).

In some cases, a test separation distance 520 (or spacing) may be adjusted (increased or decreased) depending on the transmit scenario, where the test separation distance 520 may be the distance between a radiating structure (e.g., the antenna(s) 218) and any part of the human body, in this example, the human body model 506. For example, the test separation distance 520 may be set to 15 millimeters (mm) for body-worn exposure, 0 mm for head exposure, 10 mm for a hotspot exposure, etc. In certain cases, the test separation distance 520 may differ among regions. For example, the test separation distance 520 may be set to 0 mm for body-worn exposure for a particular region, whereas the test separation distance 520 may be set to 15 mm for body-worn exposure for another region, and in some cases, using the same RF exposure limit (e.g., 1.6 W/kg averaged over 1 gram). As the test separation distance 520 may differ among some regions, the corresponding transmit power limits (e.g., Pₗᵢₘᵢₜ) may differ among these regions regardless of whether the same RF exposure limit is applied.

The processing system 502 may include a processor 508 coupled to a memory 510 via a bus 512. The processing system 502 may be a computational device such as a computer. The processor 508 may include a microprocessor, a central processing unit (CPU), a graphics processing unit (GPU), a neural networks processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. The processor 508 may be in communication with the robotic RF probe 504 via an interface 514 (such as a computer bus interface), such that the processor 508 may obtain RF measurements taken by the robotic RF probe 504 and control the position of the robotic RF probe 504 relative to the human body model 506, for example.

The memory 510 may be configured to store instructions (e.g., computer-executable code) that when executed by the processor 508, cause the processor 508 to perform various operations. For example, the memory 510 may store instructions for obtaining the RF exposure values or distributions associated with various RF exposure/transmit scenarios and/or adjusting the position of the robotic RF probe 504.

The robotic RF probe 504 may include an RF probe 516 coupled to a robotic arm 518. In some aspects, the RF probe 516 may be a dosimetric probe capable of measuring RF exposures at various frequencies such as sub-6 GHz bands and/or mmWave bands. The RF probe 516 may be positioned by the robotic arm 518 in various locations (as indicated by the dotted arrows) to capture the electromagnetic radiation emitted by the antenna(s) 218 of the first wireless device 102. The robotic arm 518 may be a six-axis robot capable of performing precise movements to position the RF probe 516 to the location (on the human body model 506) of maximum electromagnetic field generated by the wireless device 102. In other words, the robotic arm 518 may provide six degrees of freedom in positioning the RF probe 516 with respect to the antenna(s) 218 of the wireless device 102 and/or the human body model 506.

The human body model 506 may be a specific anthropomorphic mannequin with simulated human tissue. For example, the human body model 506 may include one or more liquids that simulate the human tissue of the head, body, and/or extremities. The human body model 506 may simulate the human tissue for determining the maximum permissible transmission power of the antenna(s) 218 in compliance with various RF exposure limits implemented in various regions.

In certain aspects, the RF exposure levels associated with the wireless device 102 may be measured without the human body model 506. For example, the RF probe 516 may be an electric- or magnetic-field probe capable of estimating the SAR and/or PD exposure encountered by human tissue in the free-space surrounding the wireless device 102. While the example depicted in FIG. 5 is described herein with respect to obtaining RF exposure levels with a robotic RF probe to facilitate understanding, aspects of the present disclosure may also be applied to other suitable RF probe architectures, such as using multiple stationary RF probes positioned at various locations along the human body model 506 or free-space.

For a wireless device, a particular Pₗᵢₘᵢₜ may be defined per RAT, frequency band (or carrier, channel, etc.), antenna (or antenna group), antenna configuration, and/or RF exposure scenario (e.g., head exposure, body-worn exposure, hand exposure, hotspot exposure, etc.) (collectively referred to herein as a “transmit scenario”). In some cases, the RF exposure scenario may correspond to a DSI or a particular operational state of the device, where the DSI may indicate the device position relative to a human body, e.g., head, hand, body, etc. In certain cases, Pₗᵢₘᵢₜ may correspond to a particular RF exposure design target (e.g., SAR or PD), where a separate Pₗᵢₘᵢₜ may be determined for each RF exposure distribution (or, more generally, each transmit scenario), for example, as described herein with respect to FIG. 5. As an example, Pₗᵢₘᵢₜₖ for the k^{th} RF exposure distribution may be given by:

$${P}_{limitk} = {Tx}_{k} * RF\_exposure \_design \_target / max ( RF \cdot {exp}_{k} ) \qquad ( 1 )$$

where max (RF·expₖ) is the largest RF exposure value (e.g., SAR value, incident PD value, or absorbed PD value) in the k^{th} RF exposure distribution (RF·expₖ) measured with radio at transmit power Txₖ, Txₖ is the transmit power applied at the antenna while collecting the k^{th} RF exposure distribution, and RF_exposure_design_target may be a target RF exposure limit. In certain cases, RF_exposure_design_target may be lower than the regulatory RF exposure limit to account for device uncertainties and/or to budget enough RF exposure margin to comply with total RF exposure in simultaneous transmission scenarios with other transmitters not included inside the RF exposure time-averaging operation. A regulatory exposure limit may include an RF exposure limit set by a regulatory body (e.g., the FCC) and/or provided by a standards body (e.g., the IEEE or International Commission of Non-Ionizing Radiation Protection (ICNIRP)). Thus, the time-averaged RF exposure exhibited by a wireless device may be kept in compliance with the respective regulatory RF exposure limit by maintaining the time-averaged transmit power for the k^{th} RF exposure distribution to less than or equal to Pₗᵢₘᵢₜₖ. Pₗᵢₘᵢₜₖ may vary with technology, operating frequency band, transmitting antenna, and/or device position relative to the human body (which may be referred to as “device state index”).

### Example Transmit Antenna Grouping

Multi-mode/multi-band UEs have multiple transmit antennas, which can simultaneously transmit in sub-6 GHz bands and bands greater than 6 GHz bands, such as mmWave bands. As described herein, the RF exposure of sub-6 GHz bands may be evaluated in terms of SAR, and the RF exposure of bands greater than 6 GHz may be evaluated in terms of PD. Due to the regulations on simultaneous exposure, the wireless communication device may limit maximum transmit power for both sub-6 GHz bands and bands greater than 6 GHz.

In certain cases, although antennas may be positioned in different locations across a wireless device, a time-averaging algorithm for RF exposure compliance may assume all transmit antennas are collocated in a central location on the wireless device. Under such an assumption, the total transmit power of all transmit antennas may be limited regardless of the actual exposure scenario (e.g., head exposure, body exposure, or extremity exposure) of separate antennas. For example, suppose the user's hand covers the location of the collocated model, while specific antennas are not covered by the user's hand. That is, antennas may contribute to the RF exposure differently depending on the location of the exposure. Enforcing the collocated model may lead to limiting the transmit power of specific antennas not actually covered by the user's hand. That is, the assumption that the transmit antennas are collocated for RF exposure compliance may provide a needlessly low transmit power, which may affect uplink performance such as uplink data rates, uplink carrier aggregation, and/or an uplink connection at the edge of a cell.

Certain aspects of the present disclosure provide various techniques for grouping antennas, for example, to determine RF exposure compliance on a group basis. In some aspects, the antenna groups may be defined and/or operated so as to be mutually exclusive of each other in terms of RF exposure. The RF exposure compliance and corresponding transmit power levels may be determined separately for each antenna group. The antenna grouping described herein may enable relatively higher transmit power for specific antenna groups. An antenna grouping (or set of antenna groups) may refer to a specific assignment (or grouping) of antennas into separate antenna groups. The higher transmit power may provide desirable uplink performance, such as desirable uplink data rates, uplink carrier aggregation, and/or an uplink connection at the edge of a cell.

In certain aspects, a plurality of antenna groups is defined. Each antenna group may include one or more antennas. For example, the antenna 218a may be categorized into a first antenna group, and the antenna 218b may be categorized into a second antenna group. In certain aspects, each antenna array (e.g., each phased array) is placed in a different group. The groups may be defined manually, for example by a designer or test operator, or in an automated fashion, for example by an algorithm operating prior to initialization of the device, at initialization, or during operation of the device. The groups may be established based on physical location (as described in greater detail below), operating frequency, form factor, associated method of calculating RF exposure, transmit scenario, etc.

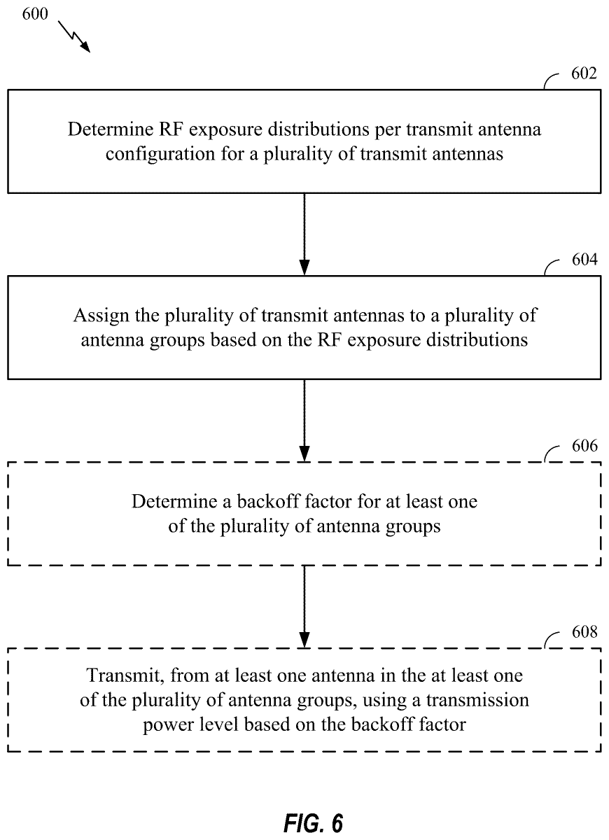

FIG. 6 is a flow diagram illustrating example operations 600 for grouping antennas for RF exposure compliance, in accordance with certain aspects of the present disclosure. The operations 600 may be performed, for example, by a wireless device (e.g., the wireless device 102), an RF exposure measurement system (e.g., the RF exposure measurement system 500), and/or a processing system. While operations 600 describe certain examples for grouping antennas, other methodologies may be used. For example, in some configurations, antennas may be grouped based at least in part on transmit scenario (e.g., single-input, multiple-output (SIMO) versus MIMO operation).

The operations 600 may begin, at block 602, where the processing system may determine (e.g., generate and/or receive) RF exposure distributions per transmit antenna configuration for a plurality of transmit antennas of a wireless device (e.g., the wireless device 102). At block 604, the processing system may assign the plurality of transmit antennas to a plurality of antenna groups based on the RF exposure distributions. Optionally, at block 606, the wireless device and/or processing system may determine a backoff factor for at least one of the plurality of antenna groups, for example, associated with a specific exposure/transmit scenario. At block 608, the wireless device may transmit, from at least one antenna in the at least one of the plurality of antenna groups, using a transmission power level based on the backoff factor.

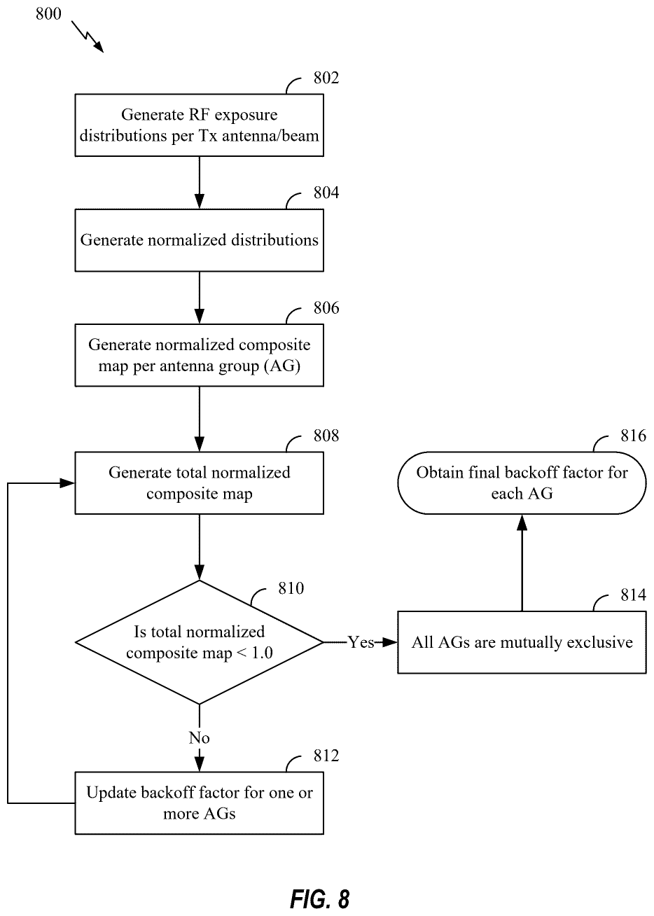

In certain aspects, assigning the plurality of transmit antennas to the plurality of antenna groups at block 604 may involve the processing system determining backoff factors for each of the antenna groups, for example, as further described herein with respect to FIG. 8. As used herein, a backoff factor may be a specific number representing a fraction (or portion) of a maximum transmit power level supported by a wireless device, such as a number in the range of 0 to 1. For example, the processing system may generate normalized distributions of the RF exposure distributions, generate a normalized composite map of the normalized distributions for each of the antenna groups, and generate a total of the normalized composite maps for all of the antenna groups based on a backoff factor associated with each of the antenna groups.

In aspects, the normalized distributions may be generated by dividing the RF exposure distributions by a maximum RF exposure value for a corresponding transmit antenna configuration, for example, as described herein with respect to block 802. In some aspects, the normalized composite map may be generated by selecting a maximum of the normalized distributions as the normalized composite map for each of the antenna groups, for example, as described herein with respect to block 804.

In certain aspects, generating the total of the normalized composite maps may be generated by multiplying the normalized composite map for each antenna group with the associated backoff factor to generate a weighted normalized composite map for each antenna group and summing the weighted normalized composite maps together, for example, as described herein with respect to block 808. In certain aspects, at least one of the backoff factors may be adjusted and applied to calculating the total of the normalized composite maps until the total of the normalized composite maps is less than or equal to a first threshold (e.g., 1.0). That is, the backoff factors associated with each antenna group may be updated and applied to the calculation of the normalized composite maps until the total of the normalized composite maps is less than or equal to the first threshold.

In certain cases, the processing system may assign each of the plurality of transmit antennas to one of the plurality of antenna groups based on the RF exposure distributions, such that no transmit antenna is in multiple antenna groups. In certain cases, the processing system may assign each of the plurality of transmit antennas to one of the plurality of antenna groups based on the RF exposure distributions, such that there is at least one transmit antenna in multiple antenna groups.

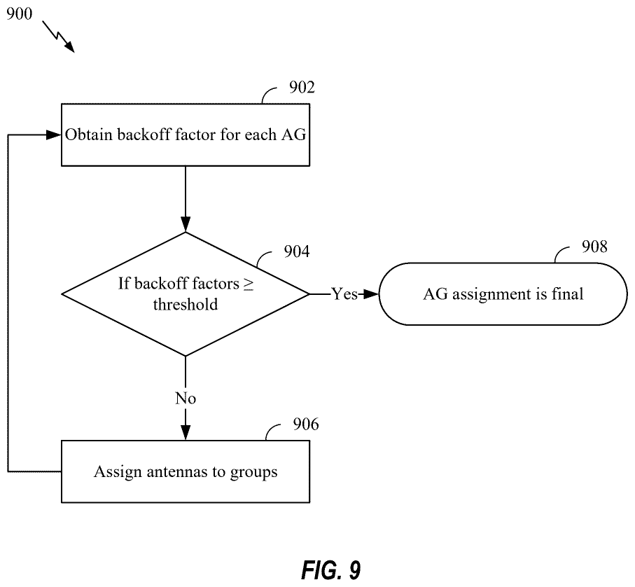

In aspects, the plurality of transmit antennas may be assigned to the plurality of antenna groups at block 604 based on the value of the determined backoff factors, for example, as further described herein with respect to FIG. 9. The transmit antennas may be redistributed or regrouped if one of the backoff factors is less than a second threshold (e.g., 0.5). For example, the processing system may determine the backoff factors for a first grouping of the antenna groups, for example, as described herein with respect to FIG. 8, and assign the transmit antennas to a second grouping of the antenna groups, if at least one of the backoff factors for the first grouping is less than a second threshold (e.g., 0.5). In certain cases, the first grouping may include a separate antenna group for each transmit antenna, and the second grouping may include at least one antenna group having multiple transmit antennas. That is, the first iteration of the antenna grouping procedure may involve determining backoff factors for each antenna and determining which transmit antennas to group together based on the backoff factors, and subsequent iterations may refine or adjust the assignment of antennas to specific antenna groups, for example, based on the determined backoff factors.

The processing system may repeat determining the backoff factors and assigning the transmit antennas to antenna groups until all of the backoff factors are greater than the second threshold. For example, the processing system may determine the backoff factors for the second grouping of the antenna groups, (e.g., repeating the operations described herein with respect to FIG. 8) and assign the transmit antennas to a third grouping of the antenna groups, if at least one of the backoff factors for the second grouping is less than the threshold. In certain cases, the third grouping may include at least two antenna groups having multiple transmit antennas in each of the at least two antenna groups. That is, the assignment of the third grouping may further refine the antenna groups to include multiple antennas in more than two antenna groups.

In certain aspects, an antenna group may include mixed-mode antennas (e.g., sub-6 GHz and mmWave antennas). For example, at least one of the antenna groups may comprise a first antenna configured to transmit in a first mode and a second antenna configured to transmit in a second mode. The first mode may be a sub-6 GHz band transmission mode, and the second mode may be a mmWave band transmission mode. In other words, the first mode may be transmitting at one or more frequencies at or below 6 GHz (for example, 300 MHz to 6 GHZ), and the second mode may be transmitting at one or more frequencies above 6 GHz (for example, 24 GHz to 53 GHz or beyond). That is, the first mode may include the first antenna being operable at one or more frequencies at or below 6 GHz, and the second mode may include the second antenna being operable at one or more frequencies above 6 GHz.

In some aspects, a transmit antenna configuration may include a specific antenna or a transmit beam configuration of an antenna module having multiple antennas. In some aspects, at least one of the transmit antennas is part of an antenna module having multiple antennas. As an example, at block 602, RF exposure distributions may be generated (and/or indications thereof may be received) for each antenna in the plurality of antennas and/or for each transmit beam configuration supported by an antenna module among the plurality of antennas. In some aspects, a transmit beam configuration may refer to a transmit radiation pattern from an antenna or antenna module in a certain azimuthal direction and/or elevation direction, which may be realized through beamforming. A transmit beam configuration may have a certain transmit power spread (e.g., a power angular spread associated with an angle of departure) in an azimuthal direction and/or elevation direction.

In certain cases, the antenna grouping may be used to determine RF exposure compliance and corresponding transmit power levels. For example, the wireless device may transmit a signal at a transmission power level based on enforcing the RF exposure compliance for at least one of the antenna groups. In certain aspects, enforcing the RF exposure compliance may include the wireless device transmitting the signal at the transmission power level that satisfies a certain RF exposure limit (e.g., a SAR limit of 1.6 watts per kilogram (1.6 W/kg) and/or a PD limit of 1.0 milliwatts per square centimeter (1.0 mW/cm²)).

In some aspects, ensuring the RF exposure compliance may include evaluating the RF exposure compliance in terms of time-averaged RF exposure such as a time-averaged SAR or a time-averaged PD over a time window. In some aspects, the time window may be in a range from 1 second to 360 seconds. For example, the time window may be 100 seconds or 360 seconds. The range from 1 second to 360 seconds is an example, and other suitable values for the time window may be used. In certain cases, the time window may be less than 1 second, such as 500 milliseconds. In certain cases, the time window may be greater than 360 seconds, such as 600 seconds.

In aspects, the wireless device may be communicating with a base station (e.g., wireless device 104). For example, at block 608, the wireless device may be transmitting, to the base station, user data on a physical uplink shared channel (PUSCH) or various uplink feedback (e.g., uplink control information or hybrid automatic repeat request (HARQ) feedback) on a physical uplink control channel (PUCCH). In certain cases, the wireless device may be a UE that communicates with another UE. For example, at block 608, the UE may be transmitting, to the other UE, user data and/or various feedback on sidelink channels.

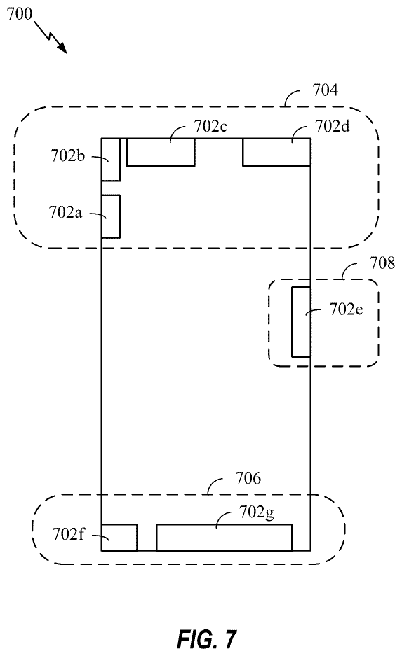

FIG. 7 is a block diagram illustrating an example grouping of multiple antennas of a wireless device 700, in accordance with certain aspects of the present disclosure. In this example, the wireless device 700 (e.g., a UE, such as a smartphone, or any of the wireless devices described herein) includes a first antenna 702a, a second antenna 702b, a third antenna 702c, a fourth antenna 702d, a fifth antenna 702c, a sixth antenna 702f, and a seventh antenna 702g. In this example, the antennas 702a-702g are separated into three antenna groups 704, 706, 708, which roughly correspond to a top of the device 700, a bottom of the device 700, and a side of the device 700, when the device 700 is held in the upright position. Those of skill in the art will appreciate that more or less than seven antennas may be implemented, and/or more or less than three antenna groupings may be defined. Each of the illustrated antennas 702a-702g may represent a single antenna, an array (e.g., a phased array) of antennas, or a module including one or more antennas. The antenna groups 704, 706, 708 may each include one or more antennas that are configured to transmit in a certain frequency band (e.g., very high (e.g., mmWave bands), high (e.g., 6-7 GHz bands), medium (e.g., 3-6 GHz bands), or low (e.g., 400 MHz-3 GHz bands)), or the antenna groups may each include one or more antennas that are configured to transmit in multiple frequency bands.

In aspects, the antenna groupings described herein may be assigned into various antenna groupings (such as an mmWave grouping, a sub-6 GHz grouping, a low band grouping (e.g., 400 MHZ-3 GHz bands), a mixed-mode grouping (e.g., mm Wave and sub-6 GHz grouping)), for example, for differing transmit scenarios. As an example, under a mmWave grouping, each mmWave module (e.g., the first antenna 702a, the third antenna 702c, and the fifth antenna 702c) may be treated as a separate antenna group, where each mmWave module may have multiple antenna elements (e.g., 64 dual polarization antenna elements) arranged in one or more arrays. The mmWave module may be capable of transmitting various beams via predefined antenna configurations, where the beams may form a codebook. Under a sub-6 GHz grouping, sub-6 GHZ antennas may be grouped into separate groups. For example, the second and fourth antennas 702b, 702d may be assigned to a group, and the sixth and seventh antennas 702f, 702g may be assigned to another group. In certain cases, the antennas 702a-702g may be assigned to a mixed-mode grouping, such as the three antenna groups 704, 706, 708.

The groups may be defined and/or operated so as to be mutually exclusive in terms of RF exposure. In certain aspects, the transmit power of one or more of the groups (or of one or more of the antennas within one or more groups) may be reduced such that the (normalized) sum of the exposure of all antenna groups, or of the overlapped RF exposure distributions, are less than a particular value (e.g., 1.0). For example, backoff factors may be determined for one or more groups, or one or more antennas within one or more groups, and applied so as to limit transmission power for the antenna(s) and/or groups.

As an example, the backoff factor bf may be between [0, 1] for each antenna group, such that the maximum permissible transmit power for each antenna group equals the respective backoff factor times the transmit power limit of the antenna group (e.g., bf*Tx_power_limit), where bf=1 represents no backoff, where bf=0.3 signifies to operate the antenna group at 30% of the transmit power limit, and where the transmit power limit may be the maximum transmit power supported by that particular antenna and/or antenna group.

FIG. 8 is a flow diagram illustrating example operations 800 for determining backoff factors for antenna groups, in accordance with certain aspects of the present disclosure. The operations 800 may be performed, for example, by a wireless device (e.g., the wireless device 102), an RF exposure measurement system (e.g., the RF exposure measurement system 500), and/or a processing system. As described above, backoff factors may be used to define antenna groups and/or operate antenna groups such that those antenna groups are mutually exclusive in terms of RF exposure. In other examples, antenna groups may be defined and/or operated so as to be mutually exclusive in terms of RF exposure using one or more other methodologies.

In order to determine backoff factors, at block 802, RF exposure distributions (simulation and/or measurement) may be generated per transmit antenna/configuration (beam) (as described above) on all evaluation surfaces/positions at all locations, for example, using a processing system and/or the RF exposure measurement system 500. In certain aspects, the RF exposure distributions may be generated via simulations, such as a simulation of the various exposure/transmit scenarios using a model of the human body being exposed to electromagnetic radiation from a wireless communication device. As previously described herein, an RF exposure distribution may include the RF exposure associated with various transmit scenarios that correspond to specific frequency bands and/or human body positions relative to the antenna. For example, the RF exposure distributions may be represented by the expression: RFexp(s,x,y,z,i), where s represents a particular surface or position, (x, y, z) represent a given location, and i represents a particular transmit configuration, such as a specific antenna or transmit beam. In certain cases, a transmit antenna may support multiple bands, so multiple RF exposure distributions for each band/channel (low/mid/high) may be available for a specific transmit antenna. In that case, the RF exposure distribution for a specific transmit antenna can represent the maximum exposure out of all technologies/bands/channels supported by the transmit antenna at each location/exposure surface.

Then, at block 804, normalized distributions (maps) may be calculated by collecting exposures on all surfaces/positions per transmit antenna/beam and dividing by the corresponding maximum value. For example, the normalized distributions may be represented by the expression: normalized·map(s,x,y,z,i)={RFexp(1,x,y,z,i); RFexp(2,x,y,z,i); . . . ; RFexp(s,x,y,z,i)}/maxRFexp(i).

Thereafter, at block 806, a normalized composite map per antenna group may be calculated, for example based on a maximum of the normalized distributions in the group. That is, generating the normalized composite map may include selecting the maximum normalized distribution among the normalized distributions in a particular antenna group. For example, a normalized composite map may be given by the expression: normalized·composite·map·AGₖ(s,x,y,z)=max {normalized·map(s,x,y,z,i), for all i=1 to n antennas/beams inside AGₖ}, where AGₖ represents a specific antenna group (AG).

Further, at block 808, a total normalized composite map may be calculated for all of the antenna groups, for example based on a sum of all of the normalized composite maps. As an example, the total normalized composite map may be given by the expression:

$$Total . normalized . composite . map ( s , x , y , z ) = {\sum }_{k = 1}^{M} \{ {bf}_{k} * normalized . composite . map . {AG}_{k} ( s , x , y , z ) \}$$

where bfₖ represents the backoff factor for a specific antenna group.

In certain aspects, at block 810, it may be determined whether the total normalized composite map is less than a threshold (for example, 1.0). If this condition is not satisfied, then the expected or potential power for one or more antennas (or one or more antenna groups) may be reduced using an updated backoff factor. Antenna groups may contribute to the RF exposure at different levels, for example, due to the location of the antennas within a group, the supported bands of the antennas within the group, the maximum transmit power of the antennas within the group, etc. The contribution of an antenna group to the RF exposure (e.g., based on the total normalized composite map, where overlapping maps are at a peak, etc.) may be adjusted using the backoff factor for the antenna group. At block 812, for example, backoff factor(s) may be adjusted (increased or decreased) for one or more of the antenna groups, and the total normalized composite map may be recalculated using the updated backoff factors at block 808. The backoff factor for each antenna and/or group may be adjusted (or updated), and the total normalized composite map may be recalculated using the adjusted backoff factors, until the condition (e.g., the total normalized composite map being less than or equal to the threshold) at block 810 is satisfied. In some examples, the backoff factor for each transmitter (or antenna, or group of antennas or transmitters) may be determined based on a proportion of RF exposure attributable to each transmitter at a (e.g., peak) location and an amount of desired reduction in exposure. In some examples, the backoff factor may be determined based on a priority of a transmitter coupled to an antenna. In some examples, the backoff factor for an antenna that contributes most to the RF exposure at a (e.g., peak) is the largest backoff factor as compared to backoff factors for other antennas or groups. In some examples, the backoff factors are determined such that transmission power level for each one of several antennas or groups contribute approximately equally to RF exposure at a location. Backoff factors may be determined or applied uniformly to antennas in a group, or may vary across antennas in the group.

At block 814, if the total normalized composite map is less than the threshold (for example, 1.0), then the antenna groups are considered to be mutually exclusive in terms of RF exposure, and at block 816, the final backoff factors for each antenna group may be obtained. The backoff factors may be used for determining transmission power levels for specific antenna groups, as further described herein, or for other purposes such as determining actual or potential interference.

FIG. 9 is a flow diagram illustrating example operations 900 for assigning antennas to groups based on the backoff factors (for example as determined in the operations 800), in accordance with certain aspects of the present disclosure. The operations 900 may be performed, for example, by a processing system including a wireless device (e.g., the wireless device 102) and/or an RF exposure measurement system (e.g., the RF exposure measurement system 500). While operations 900 describe certain examples for grouping antennas, other methodologies may be used. For example, in some configurations, antennas may be grouped based at least in part on transmit scenario (e.g., SIMO versus MIMO operation).

At block 902, the backoff factor(s) for each antenna group may be obtained, for example, after completing the operations 800 with a certain antenna grouping. For example, the operations 800 may be first performed using a separate group for each of the antennas/beams to obtain the backoff factors for individual antennas at block 902.

At block 904, it may be determined whether each of the backoff factors is greater than or equal to a threshold (for example, 0.5). If this condition is not satisfied, then, at block 906, the antennas may be reassigned or redistributed among the antenna groups. In certain cases, for antennas/antenna groups that have a low backoff factor (e.g., a backoff factor <0.5), based on spatial distribution, some of the antennas can be grouped together into the same antenna group resulting in a reduction in the number of antenna groups. Suppose, for example, in the first iteration a separate group is used for each antenna, where antennas 1-7 are in antenna groups AG1 to AG7, respectively. The corresponding backoff factors are: bf1=bf2≈0.5, bf3≈1, bf4=bf5=bf6=bf7≈0.25. Then, updated antenna groups may be AG1={Ant4, Ant5, Ant6, Ant7}, AG2={Ant1, Ant2}, and AG3={Ant3}. In certain cases, specific antennas may be grouped together such that the sum of the backoff factors for the specific antennas is above the threshold at block 904. At block 902, the operations 800 or a portion (e.g., blocks 806-816) of the operations 800 may be repeated to determine the updated backoff factors for the reassigned antenna groups. The antenna grouping/backoff factor generation may be repeated until all of the backoff factors satisfy the conditions at both block 810 and block 904. If the conditions at these blocks are satisfied, then the antenna group assignment may be considered complete.

The antenna grouping operations described herein may be determined and/or applied per DSI and/or exposure category indicating a device's exposure scenario (e.g., head exposure, body exposure, or extremity exposure) (more generally, per transmit scenario). For example, head exposure may have four exposure positions (right check, right tilt, left cheek, and left tilt), and these four positions can be collected together (e.g., at block 804, into a normalized map; in certain cases, the value of s will range from [1, 4], to account for the four exposure positions, where s represents a particular surface or position). Body exposure may have two exposure positions (front surface and back surface), and these two exposure positions can be collected together (e.g., at block 804). Extremity exposure may have six exposure positions at 0 mm separation distance (front, back, left, right, top, and bottom surfaces of device), and these six positions can be collected together (e.g., at block 804).

In certain aspects, the antenna grouping operations described herein can be combined with existing approaches for some exposure configurations, e.g., if the absolute sum of maximum RF exposure values for all antenna groups (e.g., total normalized composite map) is less than a regulatory limit, then the above procedure of adjusting the power/backoff factors may be skipped.

While the examples provided herein are described with respect to the wireless device performing various operations in determining the antenna grouping, aspects of the present disclosure may also apply to scenarios where the antenna grouping and backoff factor derivation operations are conducted in a laboratory setting (such as with the RF exposure measurement system 500), and certain calculations or simulations are performed external to the wireless device, for example, by a separate processing system (such as the processing system 502). That is, the various functions for antenna grouping and backoff factor derivation operations need not be done at the wireless device itself, but that the wireless device may be configured to store/access/utilize specific information derived from the antenna grouping operations, such as the backoff factors and antenna grouping assignments. For example, the antenna grouping assignments and corresponding backoff factors may be developed using (a prototype of) the wireless device in a laboratory setting (e.g., the RF exposure measurement system 500) to simulate various exposure/transmit scenarios during the RF exposure compliance certification process with a regulatory body, and the wireless device may be configured to store/access/utilize the backoff factors associated with the specific antenna groupings derived from the antenna grouping operations performed in the laboratory setting.

As an example, the wireless device may store and access various backoff factors associated with specific antenna groups and/or transmit beam configurations depending on the various RF exposure limit associated with the exposure/transmit scenarios (such as head exposure, body exposure, and/or extremity exposure at certain frequency bands). The backoff factors associated with the specific antenna groups and/or transit beam configurations may be developed according to the operations for assigning antenna groups as described herein, for example, using a prototype of the wireless device in a RF exposure testing laboratory. The backoff factors associated with the specific antenna groups may be arranged in a data structure, such as a table or database of backoff factors associated with specific antenna groupings at specific frequency bands and/or specific exposure/transmit scenarios.

While the examples provided herein are described with respect to the wireless device performing RF exposure compliance with the antenna grouping, aspects of the present disclosure are not limited to RF exposure use cases. For example, the stored values (e.g., the backoff factors and/or antenna grouping assignments) derived from the antenna grouping operations may be used for any number of applications. One application as further described below is to evaluate RF exposure compliance using the backoff factors and/or antenna groupings. Another application might be to determine self-interference among the antenna groupings based on transmission power levels. Other purposes are possible, as well.

In certain cases, an antenna may not meet exclusion criteria with another antenna group, and in such cases, that antenna can be incorporated into the other antenna group. In some cases, this may lead to all of the antennas being combined into a single antenna group, which implies that RF exposure from all antennas is collocated and does not take advantage of spatial diversity arising from antenna placement. One way to avoid this is to force the antenna to meet exclusion criteria by applying higher permanent backoff(s) to one or more antennas.

Certain aspects of the present disclosure relate to assigning an antenna to multiple antenna groups in a specific antenna grouping. For example, if an antenna does not meet the exclusion criteria with another antenna group, then the antenna may be assigned to multiple antenna groups, which may avoid applying a permanent backoff to all of the antennas. The antenna grouping described herein may enable desirable transmit power for specific antenna groups and/or flexibility in complying with RF exposure limits per antenna group.

Certain aspects of the present disclosure relate to assigning one or more antennas to multiple sets of antenna groups (i.e., multiple antenna groupings), for example, for separate transmit scenarios. For example, the processing system may develop an antenna grouping for a specific country or region (which may be identified by PLMN code and/or a MCC, for example) due to separate RF exposure limits for that country or region. In certain cases, the processing system may develop an antenna grouping for a specific exposure scenario, such as head exposure, body exposure, extremity exposure, and/or hotspot exposure (e.g., when the wireless communication device is not in close proximity to human tissue), and/or based on one or more operating conditions (whether MIMO is being utilized, for certain bands, when certain high priority applications or transmissions are likely to be active, etc.). Antenna groupings per transmit scenario (such as a specific region and/or exposure scenario) may provide flexibility for a wireless communication device to switch between antenna groupings depending on the transmission scenario encountered by the wireless device.

Returning to FIG. 6, the operations 600 may further involve the processing system (e.g., a wireless device, RF exposure measurement system, computer separate from the wireless device and/or any other device configured to perform the operations described herein) assigning at least one of the transmit antennas to two or more of the antenna groups at block 604. For example, the processing system may assign an antenna to multiple antenna groups due to the antenna not meeting exclusion criteria with other antenna groups. At block 604, the processing system may identify that at least one of the transmit antennas does not meet a mutually exclusive criterion with at least two of the antenna groups, and the processing system may assign the at least one of the transmit antennas to the at least two of the antenna groups in response to the identification.

In certain cases, an antenna may be assigned to multiple antenna groups based on the maximum time-averaged power limit (Pₗᵢₘᵢₜ) associated with the antenna. The maximum time-averaged power limit may refer to the maximum constant transmit power an antenna can transmit continuously during the entire duration of a time window associated with an RF exposure limit in compliance with the RF exposure limit. For example, if a certain antenna has a relatively low Pₗᵢₘᵢₜ compared to the other antennas, then the processing system may not repeat assigning that particular antenna in multiple antenna groups to avoid consuming RF exposure margin in those antenna groups. As an example, if a specific antenna has a relatively high Pₗᵢₘᵢₜ, then the processing system may assign that particular antenna to multiple antenna groups. Here, low or high Pₗᵢₘᵢₜ for a specific antenna (and a specific technology/frequency band) can be quantified by comparing the Pₗᵢₘᵢₜ against the maximum transmit power (Pₘₐₓ) supported by the hardware. In such scenarios, a peak-to-average-power ratio (PAPR) can be used as a metric to determine if Pₗᵢₘᵢₜ is relatively low or high. The PAPR in dB may be given by Pₘₐₓ−Pₗᵢₘᵢₜ, where Pₘₐₓ and Pₗᵢₘᵢₜ may be in dBm. For example, if PAPR is positive (say, a few dB, for example 2 dB, 3 dB, or 6 dB), then Pₗᵢₘᵢₜ may be considered low for that specific technology/band/antenna. Similarly, if PAPR is less than one of these example values or negative, then Pₗᵢₘᵢₜ may be considered high. With respect to the operations 600, the processing system may identify a maximum time-averaged power limit associated with each of the transmit antennas, and the processing system may assign at least one of the transmit antennas to at least two of the antenna groups based at least in part on the maximum time-averaged power limit associated with the at least one of the transmit antennas.

In certain aspects, the processing system may generate multiple antenna groupings. The antenna groupings may be developed for separate transmit scenarios, such as when a wireless communication device is located in a specific region and/or when the wireless communication device encounters a specific exposure scenario. With respect to the operations 600, the processing system may assign the transmit antennas to a first grouping of the antenna groups for a first transmit scenario (e.g., when the wireless device is located in the United States) and assign the transmit antennas to a second grouping of the antenna groups for a second transmit scenario (e.g., when the wireless device is located in the European Union).

In certain aspects, the first grouping may have a different arrangement of transmit antennas in the plurality of antenna groups than the second grouping. At least one of the transmit antennas may be in both the first grouping and the second grouping. For example, referring to FIG. 7, the antennas 702a-702g may be assigned to a first grouping where the first antenna 702a, second antenna 702b, third antenna 702c, fourth antenna 702d, and fifth antenna 702e are assigned to a first group and where the fifth antenna 702c, sixth antenna 702f, and seventh antenna 702g are assigned to a second group. The first group may be spatially separated from the second group to provide a mutually exclusive relationship in terms of RF exposure. In this first grouping, the fifth antenna 702e is assigned to two different antenna groups (namely, the first and second groups). Due to the fifth antenna 702e being positioned between the set of top and bottom antennas (702a-d, 702f, and 702g), the fifth antenna 702e may be difficult to separate into a mutually exclusive exposure group. For example, the fifth antenna 702e may interact with the other antennas (702a-d, 702f, and 702g), and to avoid applying a restrictive permanent backoff, the fifth antenna 702e may be assigned to the first group and second group.

The antennas 702a-702g may also be assigned to a second grouping, where the first antenna 702a, second antenna 702b, third antenna 702c, and fourth antenna 702d are assigned to a third group, where the sixth antenna 702f and seventh antenna 702g are assigned to a fourth group, and where the fourth antenna 702d, fifth antenna 702e, and seventh antenna 702g are assigned to a fifth group. In this second grouping, the fourth antenna 702d is assigned to two different antenna groups (namely, the third and fifth groups) and the sixth antenna 702g is assigned to two different antenna groups (namely, the fourth and fifth groups). In this second grouping, the fifth antenna 702e may again be difficult to assign to a separate group, and the fifth antenna 702e may be grouped with antennas spatially arranged on the same side of the wireless device 700, such as the fourth antenna 702d and seventh antenna 702g.

In certain cases, the first transmit scenario may be associated with a first country or region (e.g., the United States), and the second transmit scenario may be associated with a second country or region (e.g., China or the European Union). That is, the first and second transmit scenarios may depend on a specific region where the wireless device is located to comply with specific RF exposure limits for that region. When the wireless device is located in that specific region (for example as determined based on a PLMN code and/or an MCC provided to the wireless device), the wireless device may use a certain antenna grouping associated with that region.

In certain cases, the first transmission scenario may be associated with a first exposure scenario (e.g., head exposure), and the second transmission scenario may be associated with a second exposure scenario (e.g., body exposure). That is, the first and second transmission scenarios may depend on a specific exposure scenario, such as head exposure, body exposure, extremity exposure, and/or hotspot exposure. When the wireless device encounters a specific exposure scenario, the wireless device may use a certain antenna grouping associated with that exposure scenario.

In certain cases, the transmission scenarios may be associated with when certain antennas are used for concurrent transmissions. For example, suppose the fourth antenna 702d and seventh antenna 702g will be commonly used for concurrent transmissions. The processing system may assign these antennas to different groups to facilitate efficient use of the RF exposure margin for these antennas. As an example, the processing system may develop the first grouping as described herein with respect to FIG. 7 for when the fourth antenna 702d and seventh antenna 702g are used for concurrent transmissions to enable application of separate backoffs for these antennas.

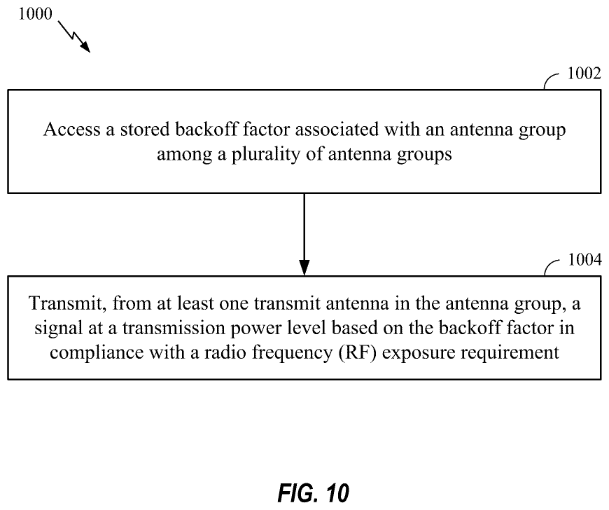

In general, with respect to the operations 600, a wireless device may transmit from at least one transmit antenna in the first grouping when operating according to a first transmit scenario, and the wireless device may transmit, from at least one transmit antenna in the second grouping when operating according to a second transmit scenario. In other words, the wireless device may select which antenna grouping to use for a specific transmit scenario, and the wireless device may switch between antenna groupings when there is a change in the transmit scenario, such as when the wireless device moves from one region to another region, for example, as further described herein with respect to FIG. 10.

### Example Time-Averaged RF Exposure Per Transmit Antenna Group

Certain aspects of the present disclosure provide various techniques for determining time-averaged RF exposure compliance per transmit antenna group. As the antenna grouping described herein may provide mutually exclusive antenna groups in terms of RF exposure, the RF exposure compliance for each antenna group may be determined separately. In certain cases, the RF exposure compliance for the antenna groups may be conducted in parallel (e.g., concurrently together). The group-based RF exposure compliance described herein may enable desirable transmit power for specific antenna groups, for example, due to differing exposure scenarios encountered by each antenna group. The desirable transmit power may provide desirable uplink performance, such as desirable uplink data rates, uplink carrier aggregation, and/or an uplink connection at the edge of a cell.

FIG. 10 is a flow diagram illustrating example operations 1000 for wireless communication, in accordance with certain aspects of the present disclosure. The operations 1000 may be performed, for example, by a wireless device (e.g., the wireless device 102). The operations 1000 may be implemented as software components that are executed and run on one or more processors (e.g., processor 210 of FIG. 2). Further, the transmission of signals by the wireless device in the operations 1000 may be enabled, for example, by one or more antennas (e.g., antennas 218 of FIG. 2). In certain aspects, the transmission and/or reception of signals by the wireless device may be implemented via a bus interface of one or more processors (e.g., processor 210) obtaining and/or outputting signals.

The operations 1000 may begin, at block 1002, where the wireless device may access a stored backoff factor associated with an antenna group (e.g., the antenna group 704) among a plurality of antenna groups (e.g., the antenna groups 704, 706, 708). At block 1004, the wireless device may transmit, from at least one transmit antenna (e.g., the antenna 702a) in the antenna group, a signal at a transmission power level based on the backoff factor in compliance with an RF exposure limit.

In certain cases, the grouping of the transmit antennas may not be an explicit indication of which antenna is in a specific group. In some aspects, the grouping of the transmit antennas may be implicitly indicated by various backoff factors assigned to transmit antennas for specific exposure/transmit scenarios. That is, the antenna groupings and the antenna group assignments associated with the antenna grouping may be represented by backoff factors. For example, certain antennas may share the same backoff factor, such that these antennas are implicitly assigned to the same antenna group among a plurality of antenna groups. In some aspects, the transmission power level may be based at least in part on at least one backoff factor of the backoff factors.

In certain aspects, the transmission power level may be determined based on a sum of the RF exposures being less than or equal to a threshold (e.g., 1.0). For example, the wireless device may transmit the signal at the transmission power level based on a sum of RF exposures for each of the antenna groups being less than or equal to a threshold. In some such scenarios, this is accomplished by applying the backoff factor(s) described above to transmission power levels.

In certain aspects, the transmission power level may be determined based on time-averaged RF exposure being less than the threshold. For example, the wireless device may transmit the signal at the transmission power level based on a time-averaged sum of RF exposures for each of the antenna groups being less than or equal to a threshold (e.g., 1.0). A backoff factor may be applied to the RF exposures for each of the antenna groups in the case of the sum of RF exposures or the time-averaged sum of RF exposures.

In aspects, the wireless device may determine time-averaged RF exposures for each of the antenna groups and use the group-based time-averaged RF exposures in determining RF exposure compliance. For example, the wireless device may transmit the signal at the transmission power level based on each of the time-averaged RF exposures being less than or equal to a threshold. In certain cases, because the antenna groups may be mutually exclusive from each other in terms of RF exposure, the wireless device may concurrently determine the time-averaged RF exposures for each of the antenna groups. In other words, the mutual exclusivity of the antenna groups may enable the wireless device to determine the time-averaged RF exposures for each of the antenna groups in parallel with (e.g., independent of) each other. Expressed another way, the wireless device may use parallel (or concurrent) processing to determine the time-averaged RF exposures for each or a portion of the antenna groups. For example, the wireless device may determine the time-averaged RF exposures associated with a first antenna group (e.g., the antenna group 704) while concurrently determining the time-averaged RF exposures associated with a second antenna group (e.g., the antenna group 706), and the wireless device may determine the transmit powers in compliance with RF exposure limits for each of the first and second antenna groups based on the respective time-averaged RF exposures and respective backoff factors. In certain cases, the wireless device may transmit the signal at the transmission power level based on enforcing RF exposure compliance for one of the plurality of antenna groups having a transmit power limit less than another one of the plurality of antenna groups. That is, the minimum of multiple transmit power limits may be enforced by the transmitter to ensure overall time-averaged RF exposure compliance.

In aspects, the antennas may have various antenna groupings, for example, as described herein with respect to the operations 600. As an example, the wireless device may have backoff factors associated with antenna groups for mmWave bands, antenna groups for sub-6 GHz bands, and/or antenna groups for mixed-mode bands (sub-6 GHZ bands and mmWave bands). In certain cases, the antenna grouping may be derived using the operations 600, 800, or 900. For example, at least one of the antenna groups may include a first antenna configured to transmit in a first mode and a second antenna configured to transmit in a second mode. In certain cases, the first mode may be sub-6 GHz, and the second mode may be mmWave. That is, the first mode may be transmitting at a sub-6 GHz band, and the second mode may be transmitting at a mmWave band. In some aspects, the first mode may include the first antenna being operable at a sub-6 GHZ band, and the second mode may include the second antenna being operable at a mmWave band.

In certain aspects, the transmit antennas may include one or more first antennas configured to transmit in a first mode and one or more second antennas configured to transmit in a second mode. The first antenna(s) may be separately assigned to the antenna groups. That is, the first antennas may be divided into groups, such that some of the first antennas may be in the same group, but one of the first antennas may not be assigned to more than one group in a specific antenna grouping. The second antennas may be included in each or some of the antenna groups. In certain cases, each of the antenna groups may have all of the second antennas. In certain cases, the first mode may be transmitting at one or more frequencies below 6 GHz (e.g., at sub-6 GHz bands), and the second mode may be transmitting at one or more frequencies above 6 GHZ (e.g., at mmWave bands). In other cases, the first mode may be transmitting at one or more frequencies above 6 GHz, and the second mode may be transmitting at one or more frequencies below 6 GHz.

In some aspects, the transmit antennas are grouped such that each antenna group is mutually exclusive from all the other antenna groups in terms of RF exposure. The mutual exclusivity of the antenna groups may be accomplished using various techniques or criteria. For example, in a system of N antennas which are grouped into k antenna groups, first obtained normalized RF exposure distribution of each of i=1 to N antennas on all exposure surfaces of interest=normalized·map(s,x,y,z,i), represented in block 804, such that the maximum value of RF exposure distributions out of all surfaces is max{normalized·map(s,x,y,z)}=1.0. Then, obtain composite map out of all n antennas inside antenna group k=normalized·composite·map·AGₖ(s,x,y,z)=max{normalized·map(s,x,y,z,i=1 to n)}, represented in block 806, =normRFexposure(k,s,x,y,z). This normalized composite map is termed as normalized RF exposure for antenna group k. For example, the mutual exclusivity of the antenna groups may be provided if a sum of RF exposure of all antenna groups (k=1 to M)<1.0 satisfies the following expression:

$${\sum }_{k = 1}^{M} \{ normRFexposur e ( k , s , x , y , z ) * predefined backoff ( k ) \} < 1. \qquad ( 9 )$$

where the predefined backoff (k) is the backoff factor applied to all the antennas and/or antenna configuration of antenna group “k.” The backoff factor may be determined based on the operations 600, 800, and/or 900, and/or the backoff factor may be stored by the wireless device (for example in the memory 282 or 338), and retrieved for use in performing the operations 1000. In certain cases, existing regulatory approaches that meet predefined criteria like SAR peak location separation ratio (SPLSR) may be used to determine such mutual exclusivity (for example, as described in Section 4.3.2c of the FCC KDB 447498 D01 General RF Exposure Guidance v06). In certain cases, the mutual exclusivity of the antenna groups may be determined by the sum of overlapped RF exposure distributions at specific backoff factors being less than or equal to a threshold (for example, 1.0). The predefined backoff factors are between [0, 1] and are applied on all the antennas belonging to that antenna group. This can be accomplished by lowering the maximum time-averaged transmission power limit of each antenna belonging to antenna group k by predefined backoff (k). Alternatively, the total RF exposure for all the antennas in the antenna group k at all spatial locations (s,x,y,z) should not exceed RFexposureₗᵢₘᵢₜ*predefined backoff(k).

As the antenna groups are mutually exclusive in terms of RF exposure, (real-time) averaging of RF exposure can be performed per antenna group (e.g., irrespective of the other antenna groups) using the methods described above or using one or more other methods. For example, RF exposure of a given antenna at any time instant t may be directly proportional to the transmission power of the antenna at t. Therefore, RF exposure for antenna i belonging to antenna group k at a time instant t may be given by:

$$RFexposure ( i , t , s , x , y , z ) = \frac{RFexposure\_peak ( i , s , x , y , z )}{Tx\_power \_peak ( i )} \times Tx\_power ( i , t ) \qquad ( 10 )$$

Time-averaged RF exposure of all n antennas and/or antenna configurations in an antenna group k over time-window T may be given by:

$$\frac{1}{T} {\int }_{t}^{t + T} [ {\sum }_{i = 1}^{n} \{ RFexposure ( i , t , s , x , y , z ) \} ] dt \leq {RFexposure}_{limit} * predefined backoff ( k ) . \qquad ( 11 )$$

The predefined backoff may be the backoff factor bf described herein.

When antennas and/or groups of antennas which use different mechanisms (e.g., SAR or PD) to calculate RF exposure are included in an antenna group, the exposures may be combined as described herein, or using one or more other methods or calculations.

Thus, transmission (power) using the antennas in the antenna groups may be controlled (e.g., by the processor 280) such that each group individually satisfies exposure limits, for example as defined by a regulator of a domestic or foreign jurisdiction. In some aspects, this may result in total power transmitted across all of the antenna groups being higher than if the antennas were not divided into mutually exclusive exposure groups.

In some cases, multiple sets of antenna groups (e.g., multiple antenna groupings) may be defined and used to determine (e.g., transmission power and/or backoff factors) settings for a plurality of transmitters and/or antennas. That is, the wireless device may be configured with multiple antenna groupings, where each antenna grouping has antenna groups that may be defined differently from the other antenna groupings. For example, referring to FIG. 7, the first antenna 702a, third antenna 702c, and fifth antenna 702e may be antenna modules having an antenna array configured to transmit at one or more mmWave bands (e.g., at approximately 24 GHz to 53 GHz or higher). The other antennas 702b, 702d, 702f, 702g may be configured to transmit at sub-6 GHz bands (e.g., 6 GHz or below).

A first antenna grouping (M1) may include three antenna groups, and a second antenna grouping (M2) may include two antenna groups. The antenna groups of the first antenna grouping (M1) may include a first antenna group (AG1) having all of the sub-6 GHz antennas 702b, 702d, 702f, 702g and the first antenna 702a, a second antenna group (AG2) having all of the sub-6 GHz antennas 702b, 702d, 702f, 702g and the third antenna 702c, and third antenna group (AG3) having all of the sub-6 GHz antennas 702b, 702d, 702f, 702g and the fifth antenna 702e. In some aspects, the first antenna grouping (M1) may be expressed as follows:
AG1: {all sub-6 GHz antennas, first mmWave module}
AG2: {all sub-6 GHz antennas, second mmWave module}
AG3: {all sub-6 GHz antennas, third mm Wave module}

The antenna groups of the second antenna grouping (M2) may include a fourth antenna group (AG4) having the second antenna 702b, fourth antenna 702d, and all of the mmWave antennas 702a, 702c, and 702e, and a fifth antenna group (AG5) having the sixth antenna 702f, seventh antenna 702g, and all of the mmWave antennas 702a, 702c, and 702e. The second antenna grouping may be expressed as follows:
AG4: {a first sub-group of sub-6 GHz antennas, all mmWave modules}
AG5: {a second sub-group of sub-6 GHz antennas, all mmWave modules}
   where the first sub-group may include the sub-6 GHz antennas arranged at the top of the wireless device (such as the second antenna 702b and fourth antenna 702d), and the second sub-group of sub-6 GHz may include the sub-6 GHz antennas arranged at the bottom of the wireless device (such as the sixth antenna 702f and seventh antenna 702g).

In some aspects, sub-6 GHz (e.g., frequency range 1 (FR1)) RF exposure may be calculated via measurements, and mmWave (e.g., frequency range 2 (FR2)) RF exposure (for beams in the codebook) may be calculated via simulations (e.g., as described above). In such cases, sub-6 GHz antennas may be grouped into M2 groups (with all mmWave modules in each of the groups), and mmWave antennas are grouped into M1 groups (with all sub-6 GHz antennas in each of the groups), as described above.

Those of skill in the art will understand that the groupings M1 and M2 are merely examples for arranging the antennas into groups to facilitate understanding. Certain aspects of the present disclosure may also be applied to arranging the antennas into additional or alternative groups, such as the groupings described above with respect to assigning an antenna to multiple groups. For example, all of either the FR1 or FR2 radios could be assigned to all of the antenna groups, and the other of the FR1 or FR2 radios could be non-uniquely spread out among the antenna groups. In one such example, an antenna grouping (M3) may include the fourth antenna group AG4 and the fifth antenna group AG5, plus an additional antenna group (AG6), having the second antenna 702b, the sixth antenna 702f, and all of the mmWave antennas 702a, 702c, and 702e. In another such example, an antenna grouping (M4) may include the fourth antenna group AG4 and a seventh antenna group (AG7), having the second antenna 702b, the sixth antenna 702f, the seventh antenna 702g, and all of the mmWave antennas 702a, 702c, and 702c.

In these examples, two or more determinations of time averaging may be performed (e.g., at least one for each set, for example according to one or more backoff values defined for the set). The processor 280 may determine to apply transmission settings to the antennas based on the results of the two or more determinations. In some aspects, the minimum of transmit power limits across the multiple antenna groupings (e.g., M1 versus M2, or M1 versus M3 and/or M4) may be selected and effected by the processor 280, for example to ensure overall time-averaged RF exposure compliance.

In certain cases, the wireless device may access a stored backoff factor and transmit, from at least one antenna, the signal using a transmission power level based on the backoff factor in compliance with a radio frequency exposure limit, as described herein. The backoff factor may correspond to at least one antenna group of a plurality of antenna groups, where the at least one antenna is in the at least one antenna group.

### Example Selection and Switching Between Sets of Antenna Groups

In certain aspects, a set of antenna groups (also referred to herein as a “grouping”) may be selected for operation by a wireless device (e.g., wireless device 102). Operating with a particular set of antenna groups may be beneficial (e.g., by offering higher performance) for a certain transmit scenario. For example, when operating with the antenna groups (AG1, AG2, and AG3) of the first antenna grouping (M1), the mmW modules may get more combined total RF exposure margin, since each mmW module can get up to 100% RF exposure margin in this scenario (depending on how much margin the sub6 antennas consume). Therefore, when operating with Long Term Evolution (LTE) and Frequency Range 2 (FR2) in NR (e.g., an LTE+FR2 link), it may be beneficial to operate according to the M1 grouping. In contrast, when operating only with sub-6 GHZ bands (e.g., LTE and Frequency Range 1 (FR1) in NR, such as in an LTE+FR1 link), it may be beneficial to operate according to the M2 grouping (with AG4 and AG5) or one of the M3 and M4 groupings, for example.

In certain aspects, the wireless device may switch between sets of antenna groups, such as when the wireless device (e.g., the wireless device 102) changes transmit scenarios. When switching from one antenna grouping to another grouping (e.g., for performance benefits), RF exposure compliance should ideally be ensured, since the grouping assumptions may have changed. For example, when switching from the M1 grouping to the M2 grouping (or from the M1 grouping to one of the M3 and M4 groupings), if each mmW module had previously operated at 100% RF exposure margin, then upon switching to the M2 grouping (e.g., from an LTE+FR2 call to an LTE+FR1 call) or one of the M3 and M4 groupings, the time-history for all the antenna groups in the M1 grouping may now exceed the RF exposure compliance limit. In some examples, a set of antenna groups may include one antenna group (as opposed to multiple antenna groups). Thus, switching between sets of antenna groups (or switching between antenna groupings) may include switching from a grouping having one antenna group to a grouping having multiple antenna groups (or vice versa).

### Example Time-Averaged RF Exposure Compliance Across Antenna Grouping Transitions

Certain aspects of the present disclosure provide techniques and apparatus for providing RF exposure compliance (e.g., time-averaged RF exposure compliance) across transitions between different antenna groupings during runtime operation of a wireless device. As described herein, in certain aspects, the wireless device may determine, generate, and/or transition between antenna groupings in real-time for a given transition in a transmit scenario in a manner that maintains compliance with a time-averaged RF exposure limit across the antenna grouping transition(s). For example, as antenna groupings change in real-time for a given transmit scenario transition, the wireless device may perform a time-averaged RF exposure operation for each updated antenna grouping (having an updated arrangement of transmit antennas), such that device level time-averaged RF exposure compliance continuity is maintained across the transmit scenario/antenna grouping transitions. As noted, a “transmit scenario” may correspond to various combinations of radios, communication technologies (e.g., RATs), transmit antennas, transmit antenna configurations, operating conditions (or modes), frequency bands (including transmit frequency band), RF exposure scenarios (e.g., head exposure, body-worn exposure, extremity (hand) exposure, and/or hotspot exposure, including device state such as open vs. closed state for foldable devices), device use-case scenarios (e.g., based on active applications on the device such as voice vs. data applications, gaming vs. video-call applications active on the device), and/or geographical locations or regions (e.g., country or region, such as the United States, China, and the European Union, among others), as illustrative, non-limiting examples.

The apparatus and methods for providing RF exposure compliance across antenna grouping transitions may provide various advantages. For example, transitioning between antenna groupings in real-time while maintaining compliance with an RF exposure limit (e.g., time-averaged RF exposure limit) across the transition(s) may allow the wireless device to avoid violations of RF exposure compliance, to improve wireless communication performance (e.g., increased throughput, decreased latency, and/or increased transmission range), or combinations thereof.

In certain aspects, maintaining RF exposure compliance across transitions between antenna groupings may involve preserving the RF exposure history for the previous antenna grouping with the new antenna grouping. For example, in certain aspects, the wireless device may track RF exposure history for each transmit antenna per antenna grouping or may include RF exposure history for a previous antenna group when determining RF exposure for a new or modified antenna group. The RF exposure history may be tracked as a function of time across different locations of a user's body.

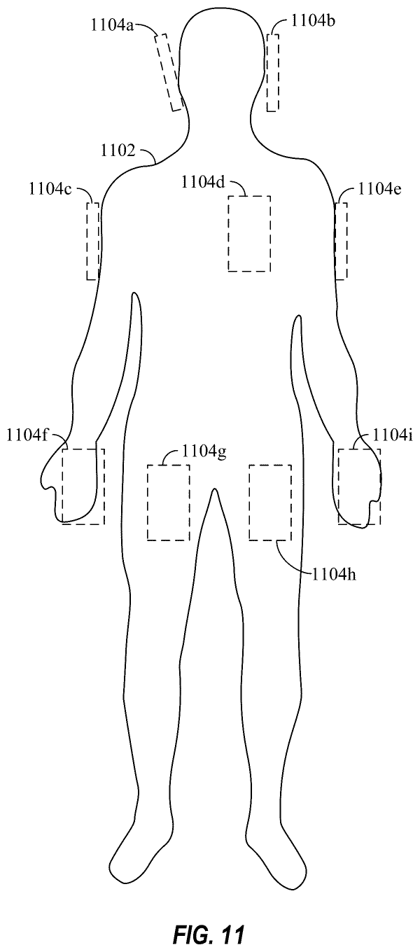

For example, depending on use case, over time, the wireless device may expose different human tissue or different parts of the human body to RF energy at different times. FIG. 11 illustrates a diagram of example wireless device locations 1104a-i (collectively “locations 1104”) relative to a profile of a user's body 1102. For example, in a first period of time, the wireless device may be held next to the head of a user for a voice call (e.g., at location 1104a, 1104b), where the RF exposure is to the head; and in a second period of time, the user may switch to using Bluetooth for the voice call and place the wireless device in a pocket (e.g., at location 1104d, 1104g, 1104h), where the RF exposure in the second time period is to both head (from a Bluetooth radio) and torso (from the wireless device). At other times, the user may position the wireless device in other locations, such as any of locations 1104c-i.

Although nine different locations 1104a-i are shown in FIG. 11, the reader is to understand that there may be more or fewer than nine different locations being assessed for exposure. The number of different locations used for RF exposure tracking may depend, for example, on the sensing and/or memory capabilities of the wireless device, on the desired tissue exposure tracking resolution, etc.

In certain aspects, for each transmit antenna within each antenna group, the time-varying RF exposure history may be recorded as a function of exposure f (exposure (i), t), where exposure (i) is the exposure recorded at time t for a particular tissue location (e.g., tissueᵢ). The tissue; may represent a unique location (or region) across multiple locations or regions across the user's body. For example, the unique location may represent a particular tissue and/or portion of the human body, such as a right or left side of the user's head; a particular hand, wrist, or arm (e.g., when the wireless device is positioned against the user's hand, wrist, or arm while exercising), fingers (e.g., when the wireless device is used for gaming), trunk (e.g., when the wireless device is in a pocket), etc. In certain cases (as described herein), for tracking and recording time-varying RF exposure history, the exposed tissue may be grouped and classified into a certain number of exposure categories, and transmitting antennas may be grouped into different antenna groups. Each exposure category may be mutually exclusive of each other in terms of RF exposure over time, and each antenna group can transmit independently for a given time. For example, for a given time, the RF exposure from any antenna in one antenna group may have no contribution to the RF exposure of an antenna in other antenna groups.

In certain aspects, RF exposure compliance continuity across antenna grouping transitions at the device level is accomplished by ensuring the time-averaged RF exposure at each location in space is maintained across antenna grouping transitions. That is, the wireless device may ensure each set of antenna groupings (used before and after transition) preserves the RF exposure history during time-averaging operation for all active transmit scenarios (including active transmit antennas, for example) supported by the wireless device.

In certain aspects, when transitioning, in real-time, from a first transmit scenario/first antenna grouping to a second transmit scenario/second antenna grouping, the wireless device may apply the second antenna grouping only on a subset of transmit antennas. For example, the wireless device may determine the second antenna grouping, such that at least one antenna group within the second antenna grouping consists of a subset of transmit antennas associated with the wireless device.

In certain aspects, the second antenna grouping for one or more (or any combination) of the transmit antennas may be applied for a specific transmit scenario (i.e., when the second transmit scenario satisfies a predetermined condition), where the specific transmit scenario includes a radio/transmit antenna (i) transitioning from an active state to an inactive state and/or (ii) transitioning from an inactive state to an active state. That is, turning a radio/antenna ON/OFF may result in a change in the antenna grouping.

By way of example, with reference to FIG. 7, consider a scenario in which a first antenna grouping (M1) includes two antenna groups: (i) AG1 with antennas 702a, 702b, 702c, and 702d and (ii) AG2 with antennas 702f and 702g. In this scenario, each antenna in the M1 grouping may be a WWAN antenna and may satisfy a mutually exclusive criterion (e.g., AG1=AG2=50% of regulatory limit, such that AG1+AG2≤ 1.0, meeting mutual exclusivity criteria). Further, assume that the wireless device includes a WLAN antenna, such as antenna 702e, that, when active, contributes 50% of the regulatory limit. If the WLAN antenna (e.g., antenna 702e) is active along with the WWAN antennas (e.g., AG1 and AG2), then the total RF exposure of AG1+AG2+antenna 702e=150% and does not meet a criterion for antenna grouping because the total RF exposure exceeds the regulatory limit.

Accordingly, assume that prior to a transition in antenna grouping, the wireless device is operating according to a first transmit scenario (i) with the M1 grouping (with AG1 and AG2) (e.g., WWAN-only antennas) and (ii) without antenna 702c (e.g., WLAN antenna). Here, because antenna 702e is not active, antenna 702e contributes zero RF exposure and is not included in the M1 grouping. As a result, the M1 grouping without antenna 702e may be RF exposure compliant at the device level. Further, assume that the wireless device transitions from operating according to the first transmit scenario to operating with a second transmit scenario, which includes an active WLAN antenna (e.g., antenna 702c) and active WWAN antennas (e.g., antennas 702a, 702b, 702c, 702d, 702f, and 702g).

In an illustrative “first” example, assume that, upon transitioning from the aforementioned first transmit scenario to the aforementioned second transmit scenario, the wireless device transitions from the M1 grouping to a second antenna grouping (M2) that includes two antenna groups: (i) AG1 with antennas 702a, 702b, 702c, 702d, 702c, 702f, and 702g (ii) AG2 with antennas 702a, 702b, 702c, 702d, 702e, 702f, and 702g. In this “first” example, because the WLAN radio has become active on antenna 702e for the second transmit scenario, the antennas 702a, 702b, 702c, 702d, 702c, 702f, and 702g may no longer be separable. Consequently, in order to maintain RF exposure compliance continuity across the transition, the wireless device may switch to the M2 grouping where each antenna group, AG1 and AG2, includes all transmit antennas 702a, 702b, 702c, 702d, 702c, 702f, and 702g.

In an illustrative “second” example, assume that, upon transitioning from the aforementioned first transmit scenario to the aforementioned second transmit scenario, the wireless device transitions from the M1 grouping to a third antenna grouping (M3) that includes three antenna groups: (i) AG1 with antennas 702a, 702b, 702c, and 702d, (ii) AG2 with antennas 702f and 702g, and (iii) AG3 with antennas 702d, 702c, and 702g. Here, the WLAN antenna (e.g., antenna 702c) may be spatially separated from antennas 702a, 702b, 702c, and 702f, but may not be spatially separated from antennas 702d and 702g. Accordingly, switching to the M3 grouping may allow the wireless device to maintain RF exposure compliance continuity across the transition.

In an illustrative “third” example, assume that, upon transitioning from the aforementioned first transmit scenario to the aforementioned second transmit scenario, the wireless device transitions from the M1 grouping to a fourth antenna grouping (M4) that includes a single antenna group, AG3 with antennas 702a, 702b, 702c, 702d, 702c, 702f, and 702g. In this “third” example, RF exposure compliance continuity may not be maintained across the transition since antenna group AG3 does not have the past RF exposure histories of AG1 and AG2.

In an illustrative “fourth” example, assume that, upon transitioning from the aforementioned first transmit scenario to the aforementioned second transmit scenario, the wireless device transitions from the M1 grouping to a fifth antenna grouping (M5) that includes three antenna groups: (i) AG4 with antennas 702a, 702b, 702c, and 702d, (ii) AG5 with antennas 702f and 702g, and (iii) AG6 with antennas 702d, 702e, and 702g. In this “fourth” example, RF exposure compliance continuity may not be maintained across the transition since antenna groups AG4, AG5, and AG6 do not have the past RF exposure histories of AG1 and AG2.

In an illustrative “fifth” example, assume that, upon transitioning from the aforementioned first transmit scenario to the aforementioned second transmit scenario, the wireless device transitions from the M1 grouping to a sixth antenna grouping (M6) that includes three antenna groups: (i) AG2 with antennas 702a, 702b, 702c, and 702d, (ii) AG1 with antennas 702f and 702g, and (iii) AG3 with antennas 702d, 702e, and 702g. In this “fifth” example, RF exposure compliance continuity may not be maintained across the transition since AG2 has the past RF exposure history of AG1 and AG1 has the past RF exposure history of AG2.

Note, in some cases, there may be a time gap between operation with the first transmit scenario and operation with the second transmit scenario. In cases where the time gap is less than a regulatory time window (e.g., the time gap is a few seconds to a few minutes), the wireless device may perform the transition from a first antenna grouping to a second antenna grouping using one or more techniques described herein so that RF exposure compliance continuity is maintained across the transition. On the other hand, in cases where the time gap is greater than a regulatory time window (e.g., the time gap is greater than a largest regulatory time window in case of multiple time windows), there may not be an impact on the time-averaged RF exposure compliance when the wireless device transitions from the first antenna grouping to the second antenna grouping, as the time-averaged RF exposure history may have cleared or timed out.

In certain aspects, the second antenna grouping for one or more (or any combination) of the transmit antennas may be applied for a specific transmit scenario (i.e., when the second transmit scenario satisfies a predetermined condition), where the specific transmit scenario includes a subset of the transmit antennas meeting a mutually exclusive criterion (e.g., SPLSR criteria). When considering RF exposure from all antennas of the wireless device, there may be scenarios where it may be difficult to separate antennas into mutually exclusive antenna groups. However, in some cases, a particular subset of the antennas may be spatially separated into different groups to provide a mutually exclusive relationship in terms of RF exposure. In such cases, RF exposure between antenna groups may be mutually exclusive when antennas in the specific subset of the antennas are active (and the remaining antennas are inactive), but RF exposure between antenna groups may not be mutually exclusive when at least one of the remaining antennas is active.

By way of example, with reference to FIG. 7, assume that the sets {antenna 702f, antenna 702g} and {antenna 702c, antenna 702d} are mutually exclusive in terms of RF exposure, but that all antennas 702a, 702b, 702c, 702d, 702c, 702f, and 702g together do not satisfy RF exposure mutual exclusivity. In this example, when antennas 702c, 702d, 702f, and 702g (or a combination thereof) are active (and each of antennas 702a, 702b, and 702e is inactive), the wireless device may use a first antenna grouping (M1) with two antenna groups: (i) AG1 with antennas 702c and 702d and (ii) AG2 with antennas 702f and 702g. On the other hand, when any of antennas 702a, 702b, and 702c is active, then the wireless device may use a second antenna grouping (M2) with two antennas groups (i) AG1 with antennas 702a, 702b, 702c, 702d, 702c, 702f, and 702g and (ii) AG2 with antennas 702a, 702b, 702c, 702d, 702c, 702f, and 702g. In this example, time-averaged RF exposure per antenna group may be independently controlled when antennas 702c, 702d, 702f, and 702g (or a combination thereof) are active; however, when any of the other antennas 702a, 702b, and 702e is active, all antennas are grouped together.

In certain aspects, the second antenna grouping for one or more (or any combination) of the transmit antennas may be applied for a specific transmit scenario (i.e., when the second transmit scenario satisfies a predetermined condition), where the specific transmit scenario includes a particular operating condition (or mode). For example, when the operating condition (or mode) of the second transmit scenario includes a MIMO transmission, the wireless device may use a first antenna grouping (M1) with one or more groups that include the antennas involved in the MIMO transmission; otherwise, the wireless device may use a second antenna grouping (M2) with one or more antenna groups, each including all of the transmit antennas. In another example, when the operating condition (or mode) of the second transmit scenario includes a non-standalone (NSA) mode in a target frequency band (e.g., FR2), the wireless device may use a first antenna grouping (M1) with one or more groups that include the antennas involved in the FR2 NSA scenario; otherwise, the wireless device may use a second antenna grouping (M2) with one or more antenna groups, each including all of the transmit antennas. Note MIMO and FR2 NSA are used as illustrative examples of operating conditions (or modes) and that the techniques described herein for may be used for other operating conditions (or modes).

By way of example, assume that a wireless device includes 8 transmit antennas (Ant1-Ant8), where Ant1/Ant2/Ant3/Ant4 are located on a 1st half of the wireless device and Ant5/Ant6/Ant7/Ant8 are located on a 2^{nd} half of the wireless device. In this example, it may be difficult to separate Ant1/Ant2/Ant3/Ant4 from Ant5/Ant6/Ant7/Ant8 (e.g., the two sets may not satisfy an SPLSR criteria). In certain cases, however, an antenna grouping for a subset of the transmit antennas (Ant1-Ant8) may be determined when the transmit scenario satisfies a predetermined condition. For example, if an antenna pair of Ant1/Ant2 and an antenna pair of Ant7/Ant8 support MIMO operation, and the output power from each of these antennas can be reduced by a predetermined amount (e.g., 3 dB) when the antennas are in MIMO operation, resulting in a MIMO transmission, then Ant1/Ant2 and Ant7/Ant8 may meet an SPLSR criteria, such that Ant1/Ant2 can be treated as one antenna group and Ant7/Ant8 can be treated as another antenna group for MIMO operations. That is, for MIMO operations and/or other predefined transmit scenarios, the antenna grouping may include (i) AG1 with Ant1/Ant2 and (ii) AG2 with Ant7/Ant8; otherwise, the antenna grouping may include one or more antenna groups for all transmit antennas (e.g., Ant1-Ant8) supported by the wireless device. Accordingly, a subset of antennas can be grouped into a set of antenna groups where these antennas meet antenna group criteria for a given transmit scenario.

In certain aspects, to maintain RF exposure compliance across antenna grouping transitions, the wireless device may ensure that the transition from a first antenna grouping to a second antenna grouping satisfies one or more conditions. In certain aspects, the one or more conditions may include both antenna groupings satisfying a mutually exclusive criterion (e.g., the antennas in the antenna groupings should be able to be spatially separated into different groups or the sum of RF exposures from all antenna groups is less than the regulatory limit on all surfaces of the device to provide a mutually exclusive relationship in terms of RF exposure). Mutual exclusivity of RF exposure from antenna groups can be demonstrated via SPLSR criteria (e.g., showing that the antennas are spatially apart) or showing that the sum of RF exposure for all antenna groups is less than a regulatory limit.

Additionally or alternatively, in certain aspects, the one or more conditions may include preserving the past RF exposure history from the (old) first antenna grouping in the (new) second antenna grouping so that the time-averaged RF exposure of the second antenna grouping includes the RF exposure history from the first antenna grouping.

In one aspect, the RF exposure history from the first antenna grouping may be preserved in the second antenna grouping when the first antenna grouping is a subset of the second antenna grouping. For example, when the old antenna grouping is a subset of the new antenna grouping, time-averaged RF exposure compliance may be maintained across the transition from the old antenna grouping to the new antenna grouping. In this aspect, the new antenna grouping may include an additional antenna(s) relative to the old antenna grouping, so that the past RF exposure history is preserved.

However, if the past RF exposure history for the old antenna grouping is not present and/or timed out (e.g., the past RF exposure history was prior to at least one previous regulatory time window), then the new antenna grouping may not be able to depend (or rely) on the RF exposure history from the old antenna grouping. In these cases, the wireless device may re-generate the past RF exposure history for the new antenna grouping. For example, if the RF exposure is tracked per antenna, then the wireless device may re-map (e.g., store) the past RF exposure history from each antenna into the new antenna grouping after transition. Note, in some cases, re-mapping the past RF exposure history into the new antenna grouping may have an impact on the device performance (e.g., dropped calls) when the sum of the past RF exposure history is greater than 100% (e.g., old AG1+old AG2>100%). However, there may not be an impact on the device performance when the sum of the past RF exposure history is less than 100% (e.g., old AG1+old AG2<100%).

Consider the following illustrative scenarios in which the wireless device operates according a first transmit scenario with WWAN-only antennas (e.g., WLAN is not active), and subsequently transitions to operating according to a second transmit scenario with WWAN and WLAN antennas (e.g., WWAN and WLAN are active). For the first transmit scenario, the wireless device may operate with a first antenna grouping (M1) grouping having two antenna groups: (i) old_AG1 with antennas 702a, 702b, 702c, and 702d and (ii) old_AG2 with antennas 702f and 702g. In the second transmit scenario, the wireless device may operate with AG1, AG2, and antenna 702c (e.g., WLAN antenna).

In an illustrative “first” example, assume that, upon transitioning from the first transmit scenario to the second transmit scenario, the wireless device transitions from the M1 grouping to a second antenna grouping (M2) that includes two antenna groups: (i) new_AG1 with antennas 702a, 702b, 702c, 702d, 702c, 702f, and 702g and (ii) new_AG2 with antennas 702a, 702b, 702c, 702d, 702e, 702f, and 702g. In this “first” example, RF exposure compliance continuity may be maintained across the transition, since the old_AG1 is a subset of new_AG1 and old_AG2 is a subset of new_AG2 (e.g., new_AG1 and new_AG2 each include the additional antenna 702c).

In an illustrative “second” example, assume that, upon transitioning from the first transmit scenario to the second transmit scenario, the wireless device transitions from the M1 grouping to a third antenna grouping (M3) that includes three antenna groups: (i) new_AG1 with antennas 702a, 702b, 702c, and 702d, (ii) new_AG2 with antennas 702f and 702g, and (iii) new_AG3 with antennas 702d, 702c, and 702g. Here, new_AG1=old_AG1, new_AG2=old_AG2, and new_AG3 is a new set of antennas. In this “second” example, RF exposure compliance continuity may be maintained across the transition, since [old_AG1, old_AG2] is a subset of [new_AG1, new_AG2, new_AG3].

In an illustrative “third” example, assume that, upon transitioning from the first transmit scenario to the second transmit scenario, the wireless device transitions from the M1 grouping to a fourth antenna grouping (M4) that includes three antenna groups: (i) AG4 with antennas 702a, 702b, 702c, and 702d, (ii) AG5 with antennas 702f and 702g, and (iii) AG6 with antennas 702d, 702c, and 702g. In this “third” example, RF exposure compliance continuity may be maintained across the transition if AG4 uses the past RF exposure history of old_AG1 and AG5 uses the past RF exposure history of old_AG2.

In an illustrative “fourth” example, assume that, upon transitioning from the first transmit scenario to the second transmit scenario, the wireless device transitions from the M1 grouping to a fifth antenna grouping (M5) that includes a single antenna group, AG3 with antennas 702a, 702b, 702c, 702d, 702e, 702f, and 702g. In this “fourth” example, RF exposure compliance continuity may be maintained across the transition if the AG3 past RF exposure history includes the sum of old_AG1 and old_AG2. However, if the sum of the past RF exposure consumption is greater than 100% prior to the transition (e.g., old_AG1+old_AG2>100%), then AG3 may drop the link after the transition assuming the link is non-compliant. On the other hand, device performance may not be impacted after the transition if the sum of the past RF exposure consumption is less than 100% prior to the transition (e.g., old_AG1+old_AG2<100%).

In certain aspects, when transitioning between different antenna groupings, the wireless device may select the new antenna grouping to transition to from among multiple different antenna groupings. For example, in some aspects, the wireless device may be pre-configured with multiple sets of antenna groupings that each satisfy one or more conditions described herein, such as a mutually exclusive criterion, as an illustrative example. In these aspects, to ensure RF exposure compliance continuity across the transition, the time-averaged algorithm (for the wireless device) can select, in real-time, a new antenna grouping from the pre-configured sets of antenna groupings, and map the past RF exposure history to the selected new antenna grouping using one or more techniques described herein. In this manner, the wireless device can ensure that the new antenna grouping remains compliant by using the past RF exposure history from the old antenna grouping.

In certain aspects, for a given set of antennas, multiple sets of antenna groupings can be predefined that meets a mutually exclusive criterion among other conditions described herein. For example, in some aspects, the multiple sets of antenna groupings can be created based on whether an antenna(s) is active or inactive. By way of example, with reference to FIG. 7, the following, non-limiting, list of antenna groups may be defined when all antennas have a Pₗᵢₘᵢₜ corresponding to an RF exposure design target:
(i) when antenna 702e is inactive, then two antenna groups: {antennas 702a, 702b, 702c, and 702d} and {antennas 702f and 702g}
(ii) when any antenna can be active, then three antenna groups: {antennas 702a, 702b, 702c, and 702d}, {antennas 702f and 702g}, and {antennas 702d, 702e, and 702g}
(iii) when any antenna can be active, then 1 antenna group: {antennas 702a, 702b, 702c, 702d, 702e, 702f, and 702g}
(iv) when only antennas 702a, 702b, 702e, and/or 702f are active, then three antenna groups: {antenna 702f}, {antenna 702e}, and {antennas 702a and 702b}.

In another aspect, the multiple sets of antenna groupings can be created by reducing Pₗᵢₘᵢₜₛ for one or more antennas. By way of another example, with reference to FIG. 7, the following, non-limiting, list of antenna groups may be defined by reducing Pₗᵢₘᵢₜₛ:
(i) when the Pₗᵢₘᵢₜ of antenna 702e is reduced by 2 dB, then two antenna groups: {antennas 702a, 702b, 702c, 702d, and 702e} and {antennas 702f and 702g}
(ii) when the Pₗᵢₘᵢₜ of antenna 702e is reduced by 5 dB, then three antenna groups: {antenna 702e}, {antennas 702a, 702b, 702c, and 702d}, and {antennas 702f and 702g}
(iii) when the Pₗᵢₘᵢₜ of antenna 702d is reduced by 2 dB and the Pₗᵢₘᵢₜ of antenna 702g is reduced by 4 dB, then three antenna groups: {antenna 702e}, {antennas 702a, 702b, 702c, and 702d}, and {antennas 702f and 702g}.

In certain aspects, for a given set of antennas, multiple sets of antenna groupings that meet a mutually exclusive criterion among other conditions described herein can be generated in real-time. In some cases, the real-time generation of antenna groupings may be based on which antennas were active in the past (based on exposure consumption) and which antennas are currently active. In some aspects, real-time generation of antenna groupings may involve (i) pre-loading one or more possible antenna grouping combinations that meet a set of regulatory criteria, (ii) loading RF exposure information from antennas (including, for example, RF exposure contributions from each antenna on all surfaces, RF exposure hotspot location information from antennas, or a combination thereof), or (iii) any combination thereof, for each transmit scenario supported by the wireless device. Using this information, the wireless device can determine a target antenna grouping(s) based on (i) past RF exposure history, (ii) active antennas for current transmission, (iii) reduction of a respective Pₗᵢₘᵢₜ for one or more active antennas, or (iv) any combination thereof, in order to meet one or more conditions described herein for a suitable antenna grouping. For example, each new antenna grouping that is dynamically generated in real-time should preserve RF exposure compliance continuity from the previous antenna grouping, e.g., by including the past RF exposure history from the previous antenna grouping.

In certain aspects, when transitioning between different antenna groupings, the wireless device may select the new antenna grouping based on a specific transmit scenario. That is, the second antenna grouping for one or more (or any combination) of the transmit antennas may be applied for a specific transmit scenario (i.e., when the second transmit scenario satisfies a predetermined condition). In certain cases, the specific transmit scenario may include a particular operating condition (or mode). For example, the wireless device may use a first antenna grouping when the operating condition (or mode) involves a single transmission (via a single transmit antenna), and may use a second antenna grouping when the operating condition (or mode) involves multiple transmissions (via multiple transmit antennas). In another example, the wireless device may use a first antenna grouping when the operating condition (or mode) involves a first set of frequency bands (e.g., first set or combination of UL frequency band), and may use a second antenna grouping when the operating condition (or mode) involves a second set of frequency bands (e.g., second set or combination of UL frequency band). In another example, the wireless device may use a first antenna grouping when the operating condition (or mode) involves a first set of active transmitting antennas and may use a second antenna grouping when the operating condition (or mode) involves a second set of active transmitting antennas. The first set of active antennas may include one or more antennas which are also in the second set of active antennas, or the first and second set may have no common antennas.

In certain aspects, the wireless device may be pre-configured with multiple sets of antenna groupings that each satisfies one or more conditions (e.g., mutually exclusive criterion, such as SPLSR, among other conditions) described herein for specific frequency band combinations, and may select the new antenna grouping to transition to from among the pre-configured multiple sets of antenna groupings.

By way of example, with reference to FIG. 7, a first antenna grouping (M1) may be defined to include two antenna groups: (i) AG1 with antennas 702a, 702b, 702c, and 702d and (ii) AG2 with antennas 702f and 702g. In the first antenna grouping (M1), antennas 702a, 702b, 702c, 702d, 702f, and 702g may be WWAN antennas that can meet a mutually exclusive criterion (e.g., the antennas in the antenna grouping should be able to be spatially separated into different groups or the sum of RF exposures from all antenna groups is less than the regulatory limit on all surfaces of the device to provide a mutually exclusive relationship in terms of RF exposure) for certain transmit frequency band(s)/band combinations. Here, the antennas in AG1 of the first antenna grouping (M1) may be mutually exclusive of antennas in AG2 of the first antenna grouping (M1) for certain transmit frequency band(s)/band combinations due to sufficient separation between RF exposure hotspots of AG1 and AG2 or due to reduced Pₗᵢₘᵢₜₛ.

However, the antennas in antenna grouping (M1) may not satisfy the mutually exclusive criterion for other/remaining transmit frequency band(s)/band combinations. For example, for these other/remaining transmit frequency band(s)/band combinations, SPLSR criteria may not be met unless Pₗᵢₘᵢₜₛ are further reduced, impacting single transmission performance of the device. Accordingly, a second antenna grouping (M2) may be defined to include a single combined antenna group with antennas 702a, 702b, 702c, 702d, 702f, and 702g for these other/remaining transmit frequency band(s)/band combinations.

By way of another example, with reference to FIG. 7, assume that all antenna pairs between antenna group 704 and antenna group 706 meet a mutually exclusive criterion (e.g., SPLSR criteria), except for the closest two antennas 702a and 702f. In this instance, when active transmitting antennas switch to an antenna 702a+antenna 702f combination, the wireless device may select the second antenna grouping (M2) with a combined antenna group that includes antennas 702a, 702b, 702c, 702d, 702f, and 702g. On the other hand, for all other active antenna combinations (e.g., one active antenna in antenna group 704+one active antenna in antenna group 706, except for antenna 702a+antenna 702f), the wireless device may select the first antenna grouping (M1) with (i) AG1 including antennas 702a, 702b, 702c, and 702d and (ii) AG2 including antennas 702f and 702g.

Consider the following illustrative transmit scenarios A and B. Transmit scenario A may involve (i) a single transmit scenario or (ii) at least one of certain transmit frequency band(s)/band combinations or certain active transmitting antenna combinations (e.g., antenna 702a+antenna 702f), for example where all antennas operate at high Pₗᵢₘᵢₜₛ that do not meet a mutually exclusive criterion (e.g., the antennas do not meet criteria for spatially separated antenna groups for all simultaneous transmission scenarios involving all antenna combinations). Consequently, for transmit scenario A, the wireless device may select the second antenna grouping (M2) with a combined antenna group that includes antennas 702a, 702b, 702c, 702d, 702f, and 702g. The set of Pₗᵢₘᵢₜₛ and exposure scenario for transmit scenario A may be defined as device state DSI_A.

Transmit scenario B may involve a multiple transmit scenario and/or certain other transmit frequency band(s)/band combinations, and/or certain other active transmitting antenna combinations (e.g., one active antenna in antenna group 704+one active antenna in antenna group 706, except for antenna 702a+antenna 702f). For example, when the device detects a multiple transmission and/or certain transmit frequency band combinations and/or certain active transmitting antenna combinations (e.g., one radio is transmitting out of AG1 and another radio is transmitting out of AG2), the wireless device may select the first antenna grouping (M1) with (i) AG1 with antennas 702a, 702b, 702c, and 702d and (ii) AG2 with antennas 702f and 702g. In certain cases, selecting the first antenna grouping (M1) in this transmit scenario may allow the wireless device to achieve higher performance as the total transmit power from the two antenna groups may be higher (with or without reduced Pₗᵢₘᵢₜₛ) than the total transmit power from a combined antenna group with antennas 702a, 702b, 702c, 702d, 702f, and 702g. The set of (reduced) Pₗᵢₘᵢₜₛ and exposure scenario for transmit scenario B may be defined as device state DSI_B.

In certain aspects, assuming the wireless device is configured with DSI_A and DSI_B, depending on the transmit scenario and/or active UL frequency band(s)/band combinations and/or active transmitting antenna combinations, the device may operate in DSI_A with a combined antenna group (e.g., combined antenna group with antennas 702a, 702b, 702c, 702d, 702f, and 702g) (with potentially higher Pₗᵢₘᵢₜₛ) or operate in DSI_B with two antenna groups AG1 and AG2 (with potentially reduced Pₗᵢₘᵢₜₛ). In some examples, the combined antenna group includes antennas from several (non-overlapping) antenna groups that are used in other transmit scenarios and/or with other band combinations. In some examples, the combined antenna group includes all antennas of the device (e.g., also including antenna 702e, or for devices in which antenna 702e is omitted), or all antennas that may be used for a certain RAT or a certain combination of RATs.

Continuing with the illustrative transmit scenarios A and B, in certain aspects, the wireless device may use one or more techniques described herein to maintain RF exposure compliance across transitions between transmit scenario A and transmit scenario B. By way of example, assume that the wireless device initially operates according to transmit scenario B, and subsequently transitions to operating according to transmit scenario A. For the transmit scenario B, the wireless device may operate with the first antenna grouping (M1) having (i) old AG1 with antennas 702a, 702b, 702c, and 702d and (ii) old AG2 with antennas 702f and 702g. For the transmit scenario A, the wireless device may operate with a second antenna grouping (M2) having (i) new AG1 with antennas 702a, 702b, 702c, 702d, 702f and 702g and (ii) new AG2 with antennas 702a, 702b, 702c, 702d, 702f and 702g. Here, old AG1 is a subset of new AG1, and old AG2 is a subset of new AG2 so that RF exposure compliance is maintained across transitions between transmit scenario A and transmit scenario B.

As can be seen from the examples above, a wireless device (e.g., the wireless device 700) may store and access an indication of which transmit scenarios and/or band (and/or RAT) combinations are associated with each (set of) antenna group(s) or antenna grouping(s). For example, such indication may indicate whether to use antenna groups at all (e.g., whether to use one group with all antennas or multiple groups). The indication may directly relate transmit scenarios and/or band combinations to antenna groupings or may indirectly relate such transmit scenarios and/or band combinations to antenna groupings (e.g., by associating a transmit scenario to a DSI, which is associated with an antenna grouping). In some examples, a transmit scenario or DSI has multiple potential associations with an antenna grouping. For example, a non-head DSI may alternatively be associated with all antennas being in a single group or with the antennas being separated into multiple groups depending on band combination, or there may be a non-head DSI which is associated with all antennas being in a single group and another non-head DSI with the antennas being separated into multiple groups, depending on, e.g., band combination.

### Example Operations for Wireless Communications

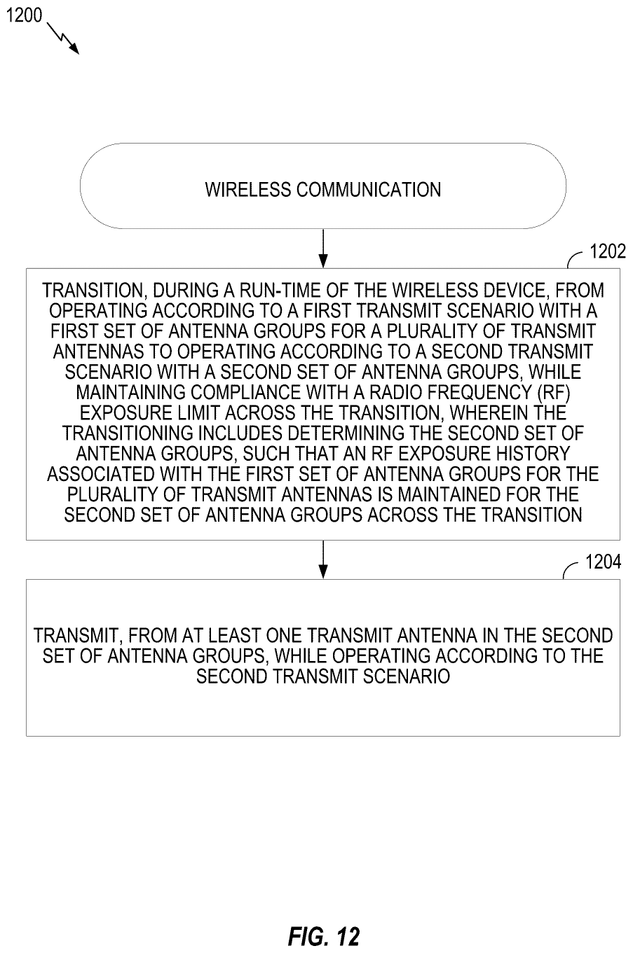

FIG. 12 is a flow diagram illustrating example operations 1200 for wireless communication. The operations 1200 may be performed, for example, by a wireless device (e.g., the wireless device 102 in the wireless communication system 100) and/or a processing system. The operations 1200 may be implemented as software components that are executed and run on one or more processors (e.g., the processor 210 and/or the modem 212 of FIG. 2).

The operations 1200 may involve, at block 1202, transitioning, during a run-time of the wireless device, from operating according to a first transmit scenario with a first set of antenna groups for a plurality of transmit antennas to operating according to a second transmit scenario with a second set of antenna groups, while maintaining compliance with a radio frequency (RF) exposure limit across the transition. The transitioning may include determining the second set of antenna groups, such that an RF exposure history associated with the first set of antenna groups for the plurality of transmit antennas is maintained for the second set of antenna groups across the transition.

In one aspect, the first set of antenna groups may be a subset of the second set of antenna groups.

Additionally or alternatively, in another aspect, determining the second set of antenna groups may involve, at block 1202, (i) obtaining, for each transmit antenna in the first set of antenna groups, an indication of a respective RF exposure for the transmit antenna; (ii) regenerating the RF exposure history associated with the first set of antenna groups, based on the RF exposures; and (iii) storing the regenerated RF exposure history for the second set of antenna groups.

The operations 1200 may also involve, at block 1204, transmitting, from at least one transmit antenna in the second set of antenna groups, while operating according to the second transmit scenario.

In certain aspects, the first set of antenna groups may have a different number of antenna groups than the second set of antenna groups.

In certain aspects, the first set of antenna groups may have a different arrangement of the plurality of transmit antennas than the second set of antenna groups.

In certain aspects, the first set of antenna groups may have a different number of the plurality of transmit antennas that are in an active state than the second set of antenna groups.

In certain aspects, each transmit scenario of the plurality of transmit scenarios includes a respective one or more radios, a respective transmit frequency band, a respective one or more transmit antennas in an active state, a respective transmit antenna configuration, a respective operating condition or mode, a respective RF exposure scenario, a respective device state index (DSI), a respective device application use-case (e.g., voice call vs. video call vs. gaming), a respective geographical location or region, or any combination thereof.

In certain aspects, the RF exposure limit is a time-averaged RF exposure limit for a time window.

In certain aspects, transitioning (at block 1202) may involve determining the second set of antenna groups, such that at least one antenna group of the second set of antenna groups consists of a subset of the plurality of transmit antennas. The second set of antenna groups may be determined when the second transmit scenario satisfies a predetermined condition. In an illustrative example, the predetermined condition may include at least one transmit antenna in the subset of the plurality of transmit antennas transitioning from (i) an active state to an inactive state or (ii) the inactive state to the active state. In another illustrative example, the predetermined condition may include each of the transmit antennas in the subset of the plurality of transmit antennas meeting a mutually exclusive criterion for the second set of the antenna groups.

In certain aspects, transitioning (at block 1202) may involve determining the second set of antenna groups for the plurality of transmit antennas when an operating mode of the second transmit scenario satisfies a predetermined condition. In an illustrative example, the predetermined condition may include at least one of (i) the operating mode comprising a multiple-input, multiple-output (MIMO) configuration of the plurality of transmit antennas or (ii) the operating mode comprising a non-standalone mode in a target frequency band for the plurality of transmit antennas.

In certain aspects, transitioning (at block 1202) may involve determining the second set of antenna groups, such that each of the first set of antenna groups and the second set of antenna groups satisfies a respective mutually exclusive criterion. In such aspects, determining the set of antenna groups includes selecting the second set of antenna groups from a plurality of sets of antenna groups, each of the plurality of sets of antenna groups satisfying the respective mutually exclusive criterion.

In one aspect, for at least one set of antenna groups in the plurality of sets of antenna groups, each of a plurality of transmit antennas in the at least one set of antenna groups has a transmission power limit that is in compliance with the RF exposure limit.

Additionally or alternatively, in some aspects, for at least one set of antenna groups in the plurality of sets of antenna groups, the operations 1200 may further involve adjusting a transmission power limit of at least one transmit antenna in the at least one set of antenna groups in compliance with the RF exposure limit.

Additionally or alternatively, in some aspects, for at least one set of antenna groups in the plurality of sets of antenna groups, the operations 1200 may further involve dynamically generating the at least one set of antenna groups in the plurality of sets of antenna groups during the transition.

In certain aspects, transitioning (at block 1202) may involve determining the second set of antenna groups, such that an RF exposure history associated with the first set of antenna groups for the plurality of transmit antennas is maintained for the second set of antenna groups across the transition.

In one aspect, the first set of antenna groups may be a subset of the second set of antenna groups.

Additionally or alternatively, in another aspect, determining the second set of antenna groups may involve (i) obtaining, for each transmit antenna in the first set of antenna groups, an indication of a respective RF exposure for the transmit antenna; (ii) regenerating the RF exposure history associated with the first set of antenna groups, based on the RF exposures; and (iii) storing the regenerated RF exposure history for the second set of antenna groups.

In certain aspects, the first transmit scenario may include a single transmission scenario or at least one of a first set of transmit frequency bands or a first set of active transmitting antennas, and the second transmit scenario may include at least one of a multiple transmission scenario, a second set of transmit frequency bands different from the first set of transmit frequency bands, or a second set of active transmitting antennas different from the first set of active transmitting antennas.

In such aspects, the first set of antenna groups (for the first transmit scenario) may include a plurality of antennas, wherein at least one of the plurality of antennas fails to satisfy a mutually exclusive criterion for the first set of transmit frequency bands or for the first set of active transmitting antennas. The first set of antenna groups may consist of a single antenna group comprising the plurality of antennas.

Additionally or alternatively, in such aspects, the second set of antenna groups (for the first transmit scenario) may include a plurality of antennas, each satisfying a mutually exclusive criterion for the second set of transmit frequency bands or for the second set of active transmitting antennas. The second set of antenna groups may include a plurality of antenna groups, each comprising a different subset of the plurality of antennas.

Additionally or alternatively, in such aspects, the operations 1200 may further involve the wireless device obtaining a first device state associated with the wireless device and obtaining a second device state associated with the wireless device. The first device state may be associated with an indication of the first set of antenna groups (for the first transmit scenario) and a respective transmission power limit for each antenna in the first set of antenna groups. The second device state may be associated with an indication of the second set of antenna groups (for the second transmit scenario) and a respective transmission power limit for each antenna in the second set of antenna groups. In some aspects, the respective transmission power limit for at least one antenna in the second set of antenna groups may be less than the respective transmission power limit for the at least one antenna in the first set of antenna groups.

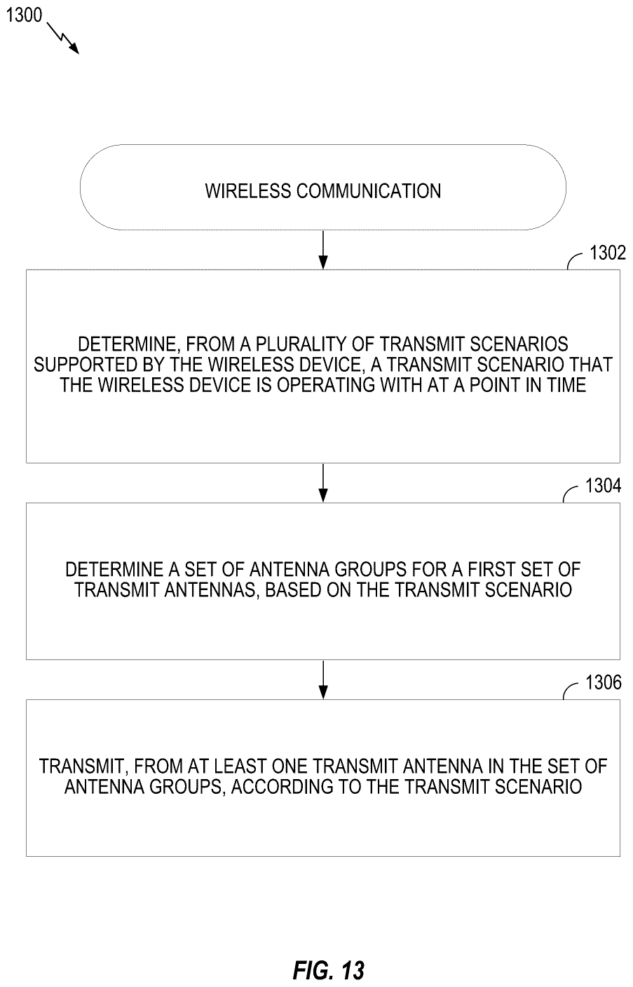

FIG. 13 is a flow diagram illustrating example operations 1300 for wireless communication. The operations 1300 may be performed, for example, by a wireless device (e.g., the wireless device 102 in the wireless communication system 100) and/or a processing system. The operations 1300 may be implemented as software components that are executed and run on one or more processors (e.g., the processor 210 and/or the modem 212 of FIG. 2).

The operations 1300 may involve, at block 1302, determining, from a plurality of transmit scenarios supported by the wireless device, a transmit scenario that the wireless device is operating with at a point in time.

The operations 1300 may also involve, at block 1304, determining a set of antenna groups for a first set of transmit antennas, based on the transmit scenario.

The operations 1300 may also involve, at block 1306, transmitting, from at least one transmit antenna in the set of antenna groups, according to the transmit scenario.

In certain aspects, each transmit scenario of the plurality of transmit scenarios includes a respective one or more radios, a respective transmit frequency band, a respective one or more transmit antennas in an active state, a respective transmit antenna configuration, a respective operating condition or mode, a respective RF exposure scenario, a respective device state index (DSI), a respective device application use-case (e.g., voice call vs. video call vs. gaming), a respective geographical location or region, or any combination thereof.

In certain aspects, the first set of transmit antennas is a subset of a second set of transmit antennas supported by the wireless device.

In certain aspects, determining the set of antenna groups comprises determining the first set of transmit antennas satisfies a predetermined condition associated with the transmit scenario.

In one aspect, the predetermined condition comprises the at least one of (i) a multiple-input, multiple-output (MIMO) configuration for the first set of transmit antennas or (ii) the first set of transmit antennas being associated with a non-standalone mode in a target frequency band. For example, the set of antenna groups may include a (i) first antenna group having a first one or more transmit antennas of the first set of transmit antennas and (ii) second antenna group having a second one or more transmit antennas of the first set of transmit antennas.

In one aspect, the predetermined condition includes at least one transmit antenna in the first set of transmit antennas transitioning from (i) an active state to an inactive state or (ii) the inactive state to the active state.

In one aspect, the predetermined condition includes each of the transmit antennas in the first set of transmit antennas meeting a mutually exclusive criterion for the set of the antenna groups.

### Example Communications Device

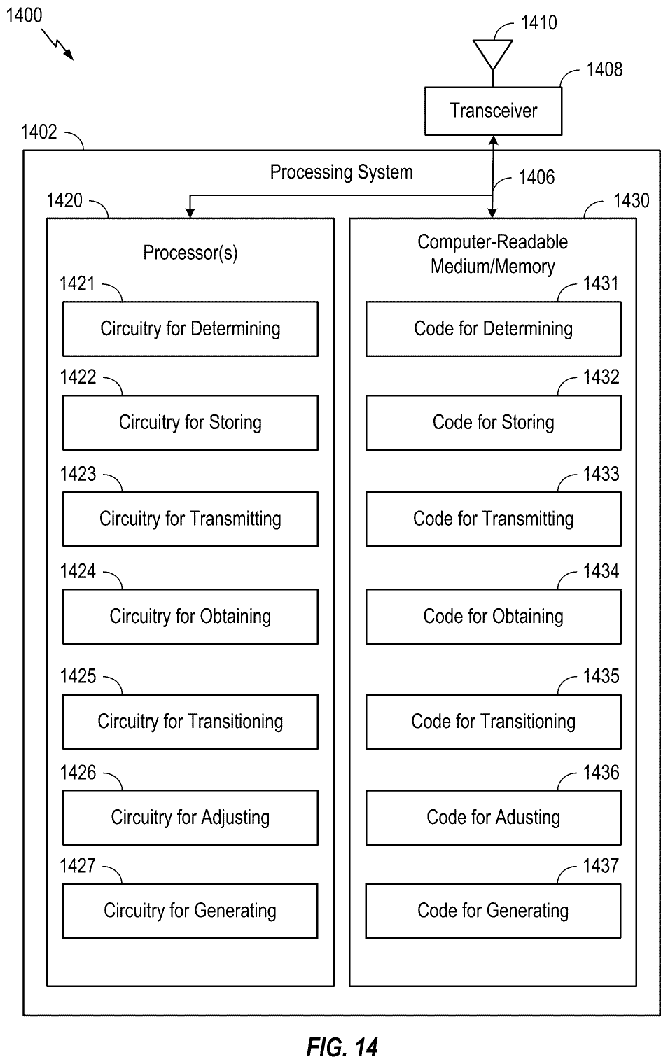

FIG. 14 depicts aspects of an example communications device 1400. In some aspects, communications device 1400 is a wireless communication device, such as the wireless device 102 described above with respect to FIGS. 1 and 2.

The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes one or more processors 1420. In various aspects, the one or more processors 1420 may be representative of any of the processor 210 and/or the modem 212, as described with respect to FIG. 2. The one or more processors 1420 are coupled to a computer-readable medium/memory 1430 via a bus 1406. In certain aspects, the computer-readable medium/memory 1430 is configured to store instructions (e.g., computer-executable code) that when executed by the one or more processors 1420, cause the one or more processors 1420 to perform the operations 600 described with respect to FIG. 6, the operations 800 described with respect to FIG. 8, the operations 900 described with respect to FIG. 9, the operations 1000 described with respect to FIG. 10, the operations 1200 described with respect to FIG. 12, the operations 1300 described with respect to FIG. 13, or any aspect related to the operations described herein. Note that reference to a processor performing a function of communications device 1400 may include one or more processors performing that function of communications device 1400.

In the depicted example, computer-readable medium/memory 1430 stores code (e.g., executable instructions) for determining (including selecting) 1431, code for storing 1432, code for transmitting 1433, code for obtaining 1434, code for transitioning (including switching or changing) 1435, code for adjusting 1436, and code for generating (including regenerating) 1437. Processing of the code 1431-1437 may cause the communications device 1400 to perform the operations 600 described with respect to FIG. 6, the operations 800 described with respect to FIG. 8, the operations 900 described with respect to FIG. 9, the operations 1000 described with respect to FIG. 10, the operations 1200 described with respect to FIG. 12, the operations 1300 described with respect to FIG. 13, or any aspect related to operations described herein.

The one or more processors 1420 include circuitry configured to implement (e.g., execute) the code stored in the computer-readable medium/memory 1430, including circuitry for determining (including selecting) 1421, circuitry for storing 1422, circuitry for transmitting 1423, circuitry for obtaining 1424, circuitry for transitioning (including switching or changing) 1425, circuitry for adjusting 1426, and circuitry for generating (including regenerating) 1427. Processing with circuitry 1421-1427 may cause the communications device 1400 to perform the operations 600 described with respect to FIG. 6, the operations 800 described with respect to FIG. 8, the operations 900 described with respect to FIG. 9, the operations 1000 described with respect to FIG. 10, the operations 1200 described with respect to FIG. 12, the operations 1300 described with respect to FIG. 13, or any aspect related to operations described herein.

Various components of the communications device 1400 may provide means for performing the operations 600 described with respect to FIG. 6, the operations 800 described with respect to FIG. 8, the operations 900 described with respect to FIG. 9, the operations 1000 described with respect to FIG. 10, the operations 1200 described with respect to FIG. 12, the operations 1300 described with respect to FIG. 13, or any aspect related to operations described herein. For example, means for transmitting, sending, or outputting for transmission may include the TX path 214 and/or antenna(s) 218 of the wireless device 102 illustrated in FIG. 2 and/or transceiver 1408 and antenna 1410 of the communications device 1400 in FIG. 14. Means for receiving or obtaining may include the RX path 216 and/or antenna(s) 218 of the wireless device 102 illustrated in FIG. 2, and/or transceiver 1408 and antenna 1410 of the communications device 1400 in FIG. 14. Means for controlling, means for performing, means for operating, means for transitioning (or switching or changing), means for refraining, means for determining, means for detecting, means for storing, means for accessing, means for adjusting, means for (re) generating, means for using, means for obtaining, and/or means for providing may include a processor, such as the processor 210 and/or modem 212 depicted in FIG. 2 and/or the processor(s) 1420 in FIG. 14.

### Example Aspects

Implementation examples are described in the following numbered clauses:
Aspect 1: A method of wireless communication by a wireless device, comprising: transitioning, during a run-time of the wireless device, from operating according to a first transmit scenario with a first set of antenna groups for a plurality of transmit antennas to operating according to a second transmit scenario with a second set of antenna groups, while maintaining compliance with a radio frequency (RF) exposure limit across the transition, wherein the transitioning comprises determining the second set of antenna groups, such that an RF exposure history associated with the first set of antenna groups for the plurality of transmit antennas is maintained for the second set of antenna groups across the transition; and transmitting, from at least one transmit antenna in the second set of antenna groups, while operating according to the second transmit scenario.
Aspect 2: The method of Aspect 1, wherein: the second set of antenna groups comprises a subset of transmit antennas supported by the wireless device; and the second set of antenna groups is determined when the second transmit scenario satisfies a predetermined condition.
Aspect 3: The method of Aspect 2, wherein the predetermined condition comprises an operating mode of the second transmit scenario indicating a multiple-input, multiple-output (MIMO) configuration for the second set of antenna groups.
Aspect 4: The method according to any of Aspects 1-3, wherein the transitioning comprises determining the second set of antenna groups, such that at least one antenna group of the second set of antenna groups consists of a subset of the plurality of transmit antennas.
Aspect 5: The method of Aspect 4, wherein the second set of antenna groups is determined when the second transmit scenario satisfies a predetermined condition.
Aspect 6: The method of Aspect 5, wherein the predetermined condition comprises at least one transmit antenna in the subset of the plurality of transmit antennas transitioning from (i) an active state to an inactive state or (ii) the inactive state to the active state.
Aspect 7: The method according to any of Aspects 5-6, wherein the predetermined condition comprises each of the transmit antennas in the subset of the plurality of transmit antennas meeting a mutually exclusive criterion for the second set of the antenna groups.
Aspect 8: The method according to any of Aspects 1-7, wherein the transitioning comprises determining the second set of antenna groups for the plurality of transmit antennas when an operating mode of the second transmit scenario satisfies a predetermined condition.
Aspect 9: The method of Aspect 8, wherein the predetermined condition comprises at least one of (i) the operating mode comprising a multiple-input, multiple-output (MIMO) configuration of the plurality of transmit antennas or (ii) the operating mode comprising a non-standalone mode in a target frequency band for the plurality of transmit antennas.
Aspect 10: The method according to any of Aspects 1-9, wherein the transitioning comprises determining the second set of antenna groups, such that each of the first set of antenna groups and the second set of antenna groups satisfies a respective mutually exclusive criterion.

Aspect 11: The method of Aspect 10, wherein determining the second set of antenna groups comprises selecting the second set of antenna groups from a plurality of sets of antenna groups, each of the plurality of sets of antenna groups satisfying the respective mutually exclusive criterion.
Aspect 12: The method of Aspect 11, wherein, for at least one set of antenna groups in the plurality of sets of antenna groups, each of a plurality of transmit antennas in the at least one set of antenna groups has a transmission power limit that is in compliance with the RF exposure limit.
Aspect 13: The method according to any of Aspects 11-12, further comprising, for at least one set of antenna groups in the plurality of sets of antenna groups, adjusting a transmission power limit of at least one transmit antenna in the at least one set of antenna groups in compliance with the RF exposure limit.
Aspect 14: The method according to any of Aspects 11-13, further comprising dynamically generating at least one set of antenna groups in the plurality of sets of antenna groups during the transition.
Aspect 15: The method according to any of Aspects 1-14, wherein the first set of antenna groups is a subset of the second set of antenna groups.
Aspect 16: The method according to any of Aspects 1-15, wherein determining the second set of antenna groups comprises: obtaining, for each transmit antenna in the first set of antenna groups, an indication of a respective RF exposure for the transmit antenna; regenerating the RF exposure history associated with the first set of antenna groups, based on the RF exposures; and storing the regenerated RF exposure history for the second set of antenna groups.
Aspect 17: The method according to any of Aspects 1-16, wherein the first set of antenna groups has a different number of antenna groups than the second set of antenna groups.
Aspect 18: The method according to any of Aspects 1-17, wherein the first set of antenna groups has a different arrangement of the plurality of transmit antennas than the second set of antenna groups.
Aspect 19: The method according to any of Aspects 1-18, wherein the first set of antenna groups has a different number of the plurality of transmit antennas that are in an active state than the second set of antenna groups.
Aspect 20: The method according to any of Aspects 1-19, wherein each of the first transmit scenario and the second transmit scenario comprises a respective one or more radios, a respective transmit frequency band, a respective one or more transmit antennas in an active state, a respective transmit antenna configuration, a respective operating condition or mode, a respective RF exposure scenario, a respective device state index (DSI), a respective device application use-case, a respective geographical location or region, or any combination thereof.
Aspect 21: The method according to any of Aspects 1-20, wherein the RF exposure limit is a time-averaged RF exposure limit for a time window.
Aspect 22: The method according to any of Aspects 1-21, wherein: the first transmit scenario comprises a single transmission scenario or at least one of a first set of transmit frequency bands or a first set of active transmitting antennas; and the second transmit scenario comprises at least one of a multiple transmission scenario, a second set of transmit frequency bands different from the first set of transmit frequency bands, or a second set of active transmitting antennas different from the first set of active transmitting antennas.
Aspect 23: The method of Aspect 22, wherein the first set of antenna groups comprises a plurality of antennas, wherein at least one of the plurality of antennas fails to satisfy a mutually exclusive criterion for the first set of transmit frequency bands or for the first set of active transmitting antennas.
Aspect 24: The method of Aspect 23, wherein the first set of antenna groups consists of a single antenna group comprising the plurality of antennas.
Aspect 25: The method according to any of Aspects 22-24, wherein the second set of antenna groups comprises a plurality of antennas, each satisfying a mutually exclusive criterion for the second set of transmit frequency bands or for the second set of active transmitting antennas.
Aspect 26: The method of Aspect 25, wherein the second set of antenna groups comprises a plurality of antenna groups, each comprising a different subset of the plurality of antennas.
Aspect 27: The method according to any of Aspects 22-26, further comprising: obtaining a first device state associated with the wireless device, the first device state being associated with an indication of the first set of antenna groups and a respective transmission power limit for each antenna in the first set of antenna groups; and obtaining a second device state associated with the wireless device, the second device state being associated with an indication of the second set of antenna groups and a respective transmission power limit for each antenna in the second set of antenna groups.
Aspect 28: The method of Aspect 27, wherein the respective transmission power limit for at least one antenna in the second set of antenna groups is less than the respective transmission power limit for the at least one antenna in the first set of antenna groups.
Aspect 29: A method of wireless communication by a wireless device, comprising: determining, from a plurality of transmit scenarios supported by the wireless device, a transmit scenario that the wireless device is operating with at a point in time; determining a set of antenna groups for a first set of transmit antennas, based on the transmit scenario; and transmitting, from at least one transmit antenna in the set of antenna groups, according to the transmit scenario.
Aspect 30: The method of Aspect 29, wherein the first set of transmit antennas is a subset of a second set of transmit antennas supported by the wireless device.
Aspect 31: The method according to any of Aspects 29-30, wherein determining the set of antenna groups comprises determining the first set of transmit antennas satisfies a predetermined condition associated with the transmit scenario.
Aspect 32: The method of Aspect 31, wherein the predetermined condition comprises at least one of (i) a multiple-input, multiple-output (MIMO) configuration for the first set of transmit antennas or (ii) the first set of transmit antennas being associated with a non-standalone mode in a target frequency band.
Aspect 33: The method according to any of Aspects 31-32, wherein the set of antenna groups comprises a first antenna group comprising a first one or more transmit antennas of the first set of transmit antennas and a second antenna group comprising a second one or more transmit antennas of the first set of transmit antennas.
Aspect 34: The method according to any of Aspects 31-33, wherein the predetermined condition comprises at least one transmit antenna in the first set of transmit antennas transitioning from (i) an active state to an inactive state or (ii) the inactive state to the active state.
Aspect 35: The method according to any of Aspects 31-34, wherein the predetermined condition comprises each of the transmit antennas in the first set of transmit antennas meeting a mutually exclusive criterion for the set of the antenna groups.
Aspect 36: The method according to any of Aspects 29-35, wherein each transmit scenario of the plurality of transmit scenarios comprises a respective one or more radios, a respective transmit frequency band, a respective one or more transmit antennas in an active state, a respective transmit antenna configuration, a respective operating condition or mode, a respective RF exposure scenario, a respective device state index (DSI), a respective device application use-case, a respective geographical location or region, or any combination thereof.
Aspect 37: An apparatus comprising: one or more memories collectively storing executable instructions; and one or more processors coupled to the one or more memories, the one or more processors being collectively configured to execute the executable instructions and cause the apparatus to perform a method in accordance with any of Aspects 1-36.
Aspect 38: An apparatus for wireless communications, comprising means for performing a method in accordance with any of Aspects 1-36.
Aspect 39: A non-transitory computer-readable medium comprising computer-executable instructions that, when executed by one or more processors of a processing system, cause the processing system to perform a method in accordance with any of Aspects 1-36.
Aspect 40: A computer program product embodied on a computer-readable storage medium comprising code for performing a method in accordance with any of Aspects 1-36.

### Additional Considerations

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, identifying, searching, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. A hardware module may include several electrical elements (e.g., one or more dies and/or other components) packaged together.

The various illustrative logical blocks, modules and circuits described in connection with the present disclosure may be implemented or performed with a general purpose processor, a digital signal processor (DSP), a neural network processor, a system on chip (SoC), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (random access memory), flash memory, ROM (read-only memory), PROM (programmable read-only memory), EPROM (erasable programmable read-only memory), EEPROM (electrically erasable programmable read-only memory), registers, magnetic disks, optical disks, hard drives, or any other suitable non-transitory storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein (e.g., instructions for performing the operations described herein and illustrated in FIGS. 6, 8-10, and 12-13).

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or other physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
transitioning, during a run-time of the wireless device, from operating according to a first transmit scenario with a first set of antenna groups for a plurality of transmit antennas to operating according to a second transmit scenario with a second set of antenna groups, while maintaining compliance with a radio frequency (RF) exposure limit across the transition, wherein the transitioning comprises determining the second set of antenna groups, such that an RF exposure history associated with the first set of antenna groups for the plurality of transmit antennas is maintained for the second set of antenna groups across the transition; and
transmitting, from at least one transmit antenna in the second set of antenna groups, while operating according to the second transmit scenario.

2. The method of claim 1, wherein:
the second set of antenna groups comprises a subset of transmit antennas supported by the wireless device;
the second set of antenna groups is determined when the second transmit scenario satisfies a predetermined condition; and
the predetermined condition comprises an operating mode of the second transmit scenario indicating a multiple-input, multiple-output (MIMO) configuration for the second set of antenna groups.

3. The method of claim 1, wherein the transitioning further comprises determining the second set of antenna groups, such that at least one antenna group of the second set of antenna groups consists of a subset of the plurality of transmit antennas.

4. The method of claim 3, wherein:
the second set of antenna groups is determined when the second transmit scenario satisfies a predetermined condition; and
the predetermined condition comprises at least one of:
at least one transmit antenna in the subset of the plurality of transmit antennas transitioning from (i) an active state to an inactive state or (ii) the inactive state to the active state; or
each of the transmit antennas in the subset of the plurality of transmit antennas meeting a mutually exclusive criterion for the second set of the antenna groups.

5. The method of claim 1, wherein:
the transitioning further comprises determining the second set of antenna groups for the plurality of transmit antennas when an operating mode of the second transmit scenario satisfies a predetermined condition; and
the predetermined condition comprises at least one of (i) the operating mode comprising a multiple-input, multiple-output (MIMO) configuration of the plurality of transmit antennas or (ii) the operating mode comprising a non-standalone mode in a target frequency band for the plurality of transmit antennas.

6. The method of claim 1, wherein the transitioning further comprises determining the second set of antenna groups, such that each of the first set of antenna groups and the second set of antenna groups satisfies a respective mutually exclusive criterion.

7. The method of claim 6, wherein determining the second set of antenna groups comprises selecting the second set of antenna groups from a plurality of sets of antenna groups, each of the plurality of sets of antenna groups satisfying the respective mutually exclusive criterion.

8. The method of claim 7, wherein, for at least one set of antenna groups in the plurality of sets of antenna groups, each of a plurality of transmit antennas in the at least one set of antenna groups has a transmission power limit that is in compliance with the RF exposure limit.

9. The method of claim 7, further comprising at least one of:
for at least one set of antenna groups in the plurality of sets of antenna groups, adjusting a transmission power limit of at least one transmit antenna in the at least one set of antenna groups in compliance with the RF exposure limit; or
dynamically generating at least one set of antenna groups in the plurality of sets of antenna groups during the transition.

10. The method of claim 1, wherein the first set of antenna groups is a subset of the second set of antenna groups.

11. The method of claim 1, wherein determining the second set of antenna groups comprises:
obtaining, for each transmit antenna in the first set of antenna groups, an indication of a respective RF exposure for the transmit antenna;
regenerating the RF exposure history associated with the first set of antenna groups, based on the RF exposures; and
storing the regenerated RF exposure history for the second set of antenna groups.

12. The method of claim 1, wherein at least one of (i) the first set of antenna groups has a different number of antenna groups than the second set of antenna groups, (ii) the first set of antenna groups has a different arrangement of the plurality of transmit antennas than the second set of antenna groups, or (iii) the first set of antenna groups has a different number of the plurality of transmit antennas that are in an active state than the second set of antenna groups.

13. The method of claim 1, wherein the RF exposure limit is a time-averaged RF exposure limit for a time window.

14. The method of claim 1, wherein:
the first transmit scenario comprises a single transmission scenario or at least one of a first set of transmit frequency bands or a first set of active transmitting antennas; and
the second transmit scenario comprises at least one of a multiple transmission scenario, a second set of transmit frequency bands different from the first set of transmit frequency bands, or a second set of active transmitting antennas different from the first set of active transmitting antennas.

15. The method of claim 14, wherein the first set of antenna groups comprises a plurality of antennas, wherein at least one of the plurality of antennas fails to satisfy a mutually exclusive criterion for the first set of transmit frequency bands or for the first set of active transmitting antennas.

16. The method of claim 15, wherein the first set of antenna groups consists of a single antenna group comprising the plurality of antennas.

17. The method of claim 14, wherein:
the second set of antenna groups comprises a plurality of antennas, each satisfying a mutually exclusive criterion for the second set of transmit frequency bands or for the second set of active transmitting antennas; and
the second set of antenna groups comprises a plurality of antenna groups, each comprising a different subset of the plurality of antennas.

18. The method of claim 14, further comprising:
obtaining a first device state associated with the wireless device, the first device state being associated with an indication of the first set of antenna groups and a respective transmission power limit for each antenna in the first set of antenna groups; and
obtaining a second device state associated with the wireless device, the second device state being associated with an indication of the second set of antenna groups and a respective transmission power limit for each antenna in the second set of antenna groups, wherein the respective transmission power limit for at least one antenna in the second set of antenna groups is less than the respective transmission power limit for the at least one antenna in the first set of antenna groups.

19. An apparatus for wireless communication, comprising:
one or more memories collectively storing executable instructions; and
one or more processors coupled to the one or more memories, the one or more processors being collectively configured to execute the executable instructions to cause the apparatus to:
transition, during a run-time of the apparatus, from operating according to a first transmit scenario with a first set of antenna groups for a plurality of transmit antennas to operating according to a second transmit scenario with a second set of antenna groups, while maintaining compliance with a radio frequency (RF) exposure limit across the transition, wherein to transition to operating according to the second transmit scenario, the one or more processors are collectively configured to execute the executable instructions to cause the apparatus to determine the second set of antenna groups, such that an RF exposure history associated with the first set of antenna groups for the plurality of transmit antennas is maintained for the second set of antenna groups across the transition; and
transmit, from at least one transmit antenna in the second set of antenna groups, while operating according to the second transmit scenario.

20. An apparatus for wireless communication, comprising:
means for transitioning, during a run-time of the apparatus, from operating according to a first transmit scenario with a first set of antenna groups for a plurality of transmit antennas to operating according to a second transmit scenario with a second set of antenna groups, while maintaining compliance with a radio frequency (RF) exposure limit across the transition, wherein the means for transitioning comprises means for determining the second set of antenna groups, such that an RF exposure history associated with the first set of antenna groups for the plurality of transmit antennas is maintained for the second set of antenna groups across the transition; and
means for transmitting, from at least one transmit antenna in the second set of antenna groups, while operating according to the second transmit scenario.
